(19) United States
(12) Patent Application Publication
(10) Pub. No.: US 2004/0138488 A1
(43) Pub. Date: Jul. 15, 2004

(54) Benzene-1 2-diol mannich bases ligands polymers and method of selective metal ions removal

(76) Inventors: David H. Solomon, Murrumbeewa (AU); Marcus J. Caulfield, Ashburton (AU); Tiziana Russo, Heidelberg Heights (AU); Rav Shaw, New Gisborne (AU); Duncan J. McAllister, Lawnton (AU)

Correspondence Address: BROOKS KUSHMAN P.C., 1000 TOWN CENTER, TWENTY-SECOND FLOOR, SOUTHFIELD, MI, 48075, US

(21) Appl. No.: 10/469,669

(22) PCT Filed: Mar. 1, 2002
(86) PCT No.: PCT/AU02/00243

(30) Foreign Application Priority Data
Mar. 1, 2001 (AU) PR 3464
Jun. 5, 2001 (AU) PR 5484

(51) Int. Cl. C07F 9/70; C07F 7/22

(52) U.S. Cl. 556/64; 556/81; 562/899

(57) ABSTRACT

A complexing ligand for forming a complex with a cation, the ligand comprising an aromatic component including two or more attachment sites for the cation, an optionally substituted amine, such as an aminoalkylene group, and a hydrocarbon chain of from 1 to 12 carbon atoms in length. The amine component of the ligand is capable of taking on an internal counterion (H+) so that the complex of the target cation and ligand has an overall neutral charge. Such ligands can be used to extract a target cation or cations from an aqueous solution. This has particular application for the separation of aluminium and silicon in aqueous liqors in a Bayer process. The ligand can be a simple compound formed by the Mannich condensation of catechol with formaldehyde and an amine. The ligand may alternatively be a bis-ligand, a polymer or an ion exchange resin. A range of new compounds and intermediates are also described.

### FIELD OF THE INVENTION

The present invention relates to a complexing ligand, new compounds, polymers, complexes and processes suitable for selectively removing target cations from solutions.

### BACKGROUND OF THE INVENTION

The selective removal of metal ions is a difficult problem confronting the minerals industry today. Worldwide, the minerals industry employs hundreds of thousands of people and as such significantly contributes to the global economy.

When a raw mineral is mined from the ground, there are usually several steps that are needed before useful products are obtained. This usually involves multiple steps and often contributes significantly to the cost of the process. The efficiency of the process also depends on several factors including the properties and grade of the mineral bearing ore, any necessary pretreatment of raw materials and the proficiency of the extractive metallurgical step.

Mining companies invest considerable time and money into improving existing separation techniques, and in the development of new methodologies. There are however numerous unresolved issues facing the industry, one of the most challenging ones continue to be the selective efficient removal of metal ions from solutions.

The problems associated with the removal of metals ions are exemplified by the proposed titaniferous process as outlined in U.S. Pat. No. 5,885,536. The process is made economically unviable as major difficulties are encountered because of the formation of insoluble silicon and aluminium by-products. These products are readily formed unless steps are taken to minimize the concentration of aluminium present during critical stages in the process. This requires additional complicated processing steps, which detract from the economics of the process. This process therefore suffers from difficulties due to the presence of soluble silicon and aluminium phases and it would be beneficial if these metal ions could be removed.

Another example of a system that would benefit from the removal of unwanted metal ions is the Bayer process. The Bayer process has been used commercially for about 100 years and it is well known to persons of skill in the art. It is used to extract alumina from aluminium-bearing ores, collectively known as bauxites, which is subsequently reduced in a second stage to aluminium metal.

There are also numerous other processes that are hampered due to the presence of unwanted metal ions. It would therefore be beneficial to develop methodology for the removal of metals ions from solutions, and preferably, without one or more of the disadvantages of the present systems.

### SUMMARY OF THE INVENTION

The present invention provides for a system whereby metal ions can be complexed with ligands and removed from solutions. As a consequence of the way this system operates, the ligands can be completely recycled, making the system economically attractive for large-scale separations. Many of the ligands developed for use in such applications are novel per se, and accordingly the present invention also provides such novel compounds.

Accordingly, in one aspect of the invention, there is provided a range of compounds suitable for use as ligands, or as precursors in the synthesis of ligands, the compounds being of the formula (I):

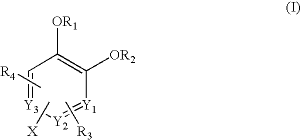

in which:

R₁ and R₂ are independently H, optionally substituted alkyl, alkenyl alkynyl or aryl, or an oxygen protecting group;

R₃ is H, an optionally substituted alkyl, alkenyl, alkynyl or aryl, or an optionally substituted carbocyclic, heterocyclic, aromatic or heteroaromatic ring, or series of rings, fused to the ring of formula (I) represented above;

R₄ is H, —OR₅ or any other non-deleterious substituent;

R₅ is H or an optionally substituted alkyl, alkenyl, alkynyl or aryl;

Y₁, Y₂ and Y₃ are each independently CH or N; and

X is an amine, including aminoalkylene, aminoalkenylene or aminoalkynylene.

The term “amine” used either alone or in a compound word is used in this specification in its broadest sense. It includes within its scope any group that includes an amino nitrogen atom which is basic in nature. In includes amino, alkylamino (for example methylamino), dialkylamino (for example dimethylamino or methylethylamino), aminoalkylene (for example aminomethylene (—CH₂NRₓR_{y} or aminoethylene), aminoalkenylene, aminoalkenylene and so forth. It is not intended to cover amido substituents, which are not basic in nature.

Preferably the compound is not a compound of formula (I) in which R₁, R₂, R₃ and R₄ are H, Y₁, Y₂ and Y₃ are CH, and X is one of CH₂NH₂, CH₂N(CH₃)₂, CH₂N(CH₂CH₃)₂, CH₂N(n-propyl)₂, CH₂N(iso-propyl)₂, CH₂N(n-butyl)₂, CH₂N(cyclohexyl)₂, or CH₂N(CH₂)₅, and X is positioned ortho to the substituent OR₂.

Preferably R₁ and R₂ are independently selected from H or alkyl, and at least one of R₁ and R₂ is H.

Preferably, X is an optionally substituted saturated or unsaturated alkylamino, di(alkyl)amino, aminoalkyl, alkylaminoalkyl, or di(alkyl)aminoalkyl. More preferably X is an unsubstituted alkylamino, di(alkyl)amino, aminoalkyl, alkylaminoalkyl, or di(alkyl)aminoalkyl.

Preferably X is an aminoalkyl group of the general structure:

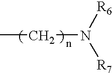

wherein:

R₆ and R₇ are the same or different, and are each an optionally substituted straight chained, branched or cyclic alkyl group, which may be linked together to form a heterocyclic group containing the nitrogen atom illustrated, or one or both of R₅ and R₇ may be linked to another site on the compound to form a cyclic group containing the nitrogen atom illustrated, and

n is 0 or a positive integer (and preferably a positive integer, most preferably 1).

Preferably R₆ and R₇ are independently a straight chained or branched C₁-C₁₀ alkyl group, a C₄-C₁₀ cyclic alkyl group or together form cyclic group containing from 4 to 10 carbon atoms, and one or more heteroatoms selected from oxygen, nitrogen and sulphur. More preferably R₆ and R₇ are independently selected from the group consisting of methyl, ethyl, propyl, butyl, pentyl, hexyl, octyl, and decyl, including the isomers thereof.

In the simplest situation, Y₁ is CH and X is positioned ortho to the group OR₂.

Preferably Y₁, Y₂ and Y₃ are each CH. It will be understood to persons skilled in the art of the invention that when a substituent such as X, R₃ or R₄ is attached at one of Y₁, Y₂ or Y₃, the hydrogen atom referred to in “CH” will be replaced with that substituent.

In the situation where the compound defined above is used as a ligand for a cation, it is preferred that R₁ and R₂ are each H. Such compounds are conveniently synthesised with few reaction side products by proceeding through an intermediate in which R₁ is alkyl, such as CH₃ and R₂ is H.

Aside from the novel compounds outlined above, the inventors have recognised that certain new complexing ligands can be made with an internal base, which when complexed with the target cation, result in the formation of an internal salt, so that the complex has an overall neutral charge. This overall uncharged complex is thereafter much more amenable to solvent extraction techniques. As a result, it is envisaged that the complexing ligand could be used in a selective process for the removal of one target ion from another, such as silicon from aluminium or aluminium from silicon.

Accordingly, in another aspect, the present invention provides a ligand system that is capable of forming complexes with metal ions. The unique characteristics of these complexes make them amenable to removal by conventional methods including solvent extraction techniques.

The present invention accordingly provides a complexing ligand for forming a complex with a cation, the ligand comprising an aromatic component including two or more attachment sites for the cation, an amine which may optionally be substituted, and a hydrocarbon chain of from 1 to 12 carbon atoms in length. The amine component of the ligand is capable of taking on an internal counterion (H+) so that the complex of the target cation and ligand has an overall neutral charge. The hydrocarbon chain functions to improve the hydrophobic (or the organophilic) nature of the ligand to assist in forming a complex that will report to an organic phase in preference to an aqueous phase. Such ligands can be used to extract a target cation or cations from an aqueous solution.

It will be understood to persons skilled in the art that this ligand can include these three components, optionally together with other components, in a wide variety of arrangements. For example, the hydrocarbon chain may be attached directly to the aromatic ring, or may be attached to the amine nitrogen. The only restriction on the arrangements possible is that the three components must be capable of performing their intended function described above in the overall ligand. The use of such compounds as ligands for forming complexes with cations, the complexes having an overall neutral charge without an external counter-ion, has hitherto been unknown.

Compounds of the formula:

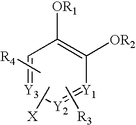

in which R₁, R₂, R₃ and R₄ are H, Y₁, Y₂ and Y₃ are CH, and X is CH₂NH₂, CH₂N(CH₃)₂, CH₂N(CH₂CH₃)₂, CH₂N(Propyl)₂, CH₂N(cyclohexyl)₂, or CH₂N(CH₂)₅, and X is positioned ortho to the substituent OR₂ have been disclosed in the prior art, but their ability to form complexes with cations which take on an internal counterion so that the complex has an overall neutral charge is not known.

The cations that may be complexed with the ligand of the present invention are any of the metal cations, or one of the metal-like cations silicon, boron, germanium, arsenic and selenium. Preferably the cation is selected from the group consisting of aluminium, silicon, titanium, boron, gallium, germanium, indium, tin, lead, uranium, gold, silver, arsenic, selenium, cadmium, mercury, chromium, copper and iron.

As explained above, when two or more of the ligands are complexed to the cation, the amine nitrogen on at least one of the ligands is protonated so that the complex has an overall neutral charge and can be extracted into an organic solvent. The inventors have found that the amine nitrogen does not, in such ligands, form a direct bond with the cation complexed to the ligand of the invention.

Preferably the two attachment sites for the cation are in an ortho relationship with respect to one another. More preferably, the two attachment sites for the cation are hydroxy groups.

Preferably the amino group of the ligand is an aminoalkyl substituent that can be protonated as required providing internal counter-ions to the target cation.

Preferably the ligand is a chelating ligand.

Preferably the ligand includes an aromatic component. This component is advantageous as the attachment sites for the cation are held in an appropriate spatial relationship with respect to each other. In addition, it is envisaged that the chemistry of the ligand might be modified by adding other substituents to the aromatic ring to affect the electronic properties of the ligand so that it may preferentially complex with a particular target metal ion.

Examples of ligands in this class include the following:

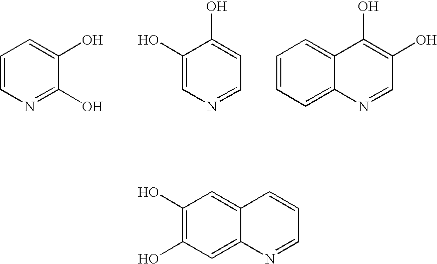

Preferably the ligand includes an aromatic component including two or more attachment sites for the cation, an amine providing an internal base, and a hydrocarbon chain that provides a hydrophobic tail. More preferably, the hydrocarbon chain length is selected so that a complex of the ligand and a target metal ion will be soluble in a selected organic phase. In some instances, it is preferred that the hydrocarbon chain contains at least 4 carbon atoms.

Examples of ligands in this class include the following:

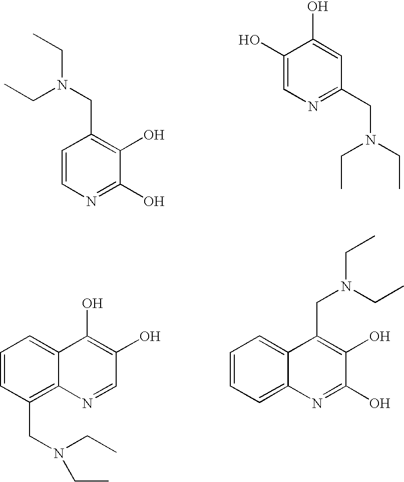

As will be evident from the above discussion, the ligand is preferably one of the class of compounds of formula (1) outlined above.

Examples of compounds within this class are as follows:

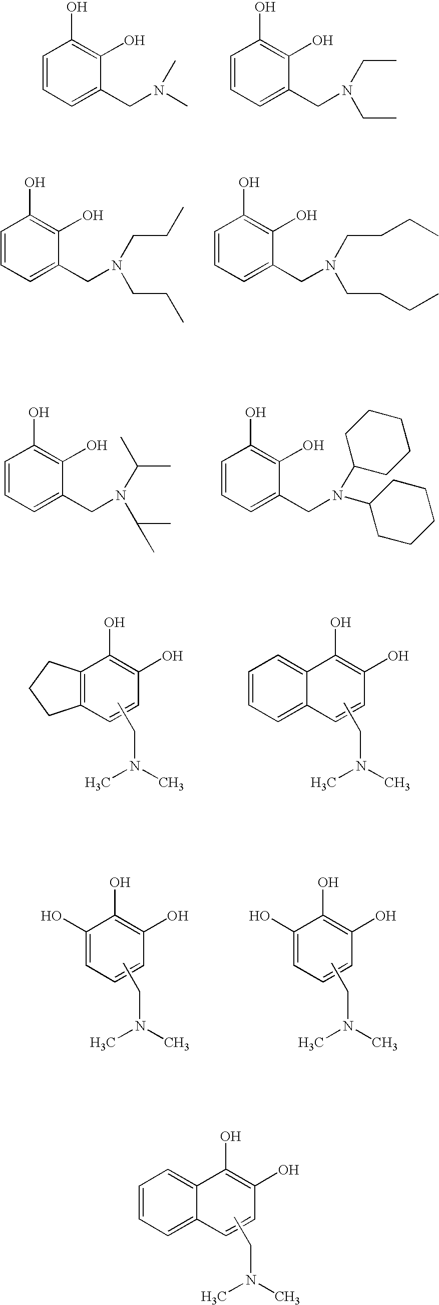

As explained above, the complexing ligand is suitable for use in a method for extracting a target cation from an aqueous solution. The length of the groups R₆ and R₇ will therefore be selected according to the organic phase to be used in the extraction step. Routine experimentation can be used to identify a substituent of suitable length to enable separation into the organic phase. The length of the groups R₆ and R₇ will also be dependent on the metal ion being complexed and the availability of the amine required to synthesize the ligand. Another important consideration is the added molecular weight as a result of a longer chain length for a single ligand and the consequent increase in the equivalent weight to complex a given amount of ions. In some instances a longer chain length may also inhibit complexation with a given metal ion. The chain length chosen will be a compromise between all of these factors.

According to one embodiment of this compound of the present invention, R₁ is CH₃. It has been found by the present applicant that the mono alkyl ethers of the catechol Mannich bases (in which R₁ is CH₃ and R₂ is H) are advantageous intermediates to go through in the synthesis of the compounds of the embodiment of the invention described above.

According to another embodiment of the invention, there is provided a compound of the formula:

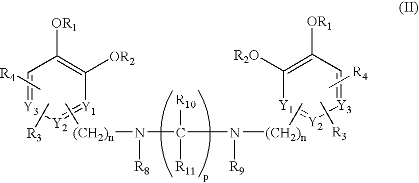

wherein:

R₁ and R₂ are independently H, optionally substituted alkyl, alkenyl alkynyl or aryl, or an oxygen protecting group;

R₃ is H, an optionally substituted alkyl, alkenyl, alkynyl or aryl, or an optionally substituted carbocyclic, heterocyclic, aromatic or heteroaromatic ring, or series of rings, fused to the respective ring or rings represented above;

R₄ is H, —OR₅ or any other non-deleterious substituent;

R₅ is H or an optionally substituted alkyl, alkenyl, alkynyl or aryl;

Y₁, Y₂ and Y₃ are each independently CH or N;

n is 0 or a positive integer;

p is a positive integer;

R₈ and R₉ are the same or different, and are each an optionally substituted straight chained, branched or cyclic alkyl group, or R₈ and R₉ may together form a substituted or unsubstituted, straight chained, branched or cyclic alkyl group linking the two nitrogen atoms; and

R₁₀ and R₁₁ are the same or different, and are each H or a substituted or unsubstituted branched or straight chained alkyl group.

Preferably the compound is not one selected from the group consisting of

3,3′-[ethylenebis(methyliminomethylene)]di(benzene-1,2-diol);

6,6′-dimethoxy-2,2′-[ethylenebis(methyliminomethylene)]diphenol;

6,6′-dimethoxy-2,2′-[ethylenebis(ethyliminomethylene)]diphenol;

6,6′-dimethoxy-2,2′-[propane-1,3-diylbis(methyliminomethylene)]diphenol;

6,6′-dimethoxy-2,2′-(piperazine-1,4-diylbismethylene)diphenol;

3,3′-[ethylenebis(ethyliminomethylene)]di(benzene-1,2-diol);

3,3′-[propane-1,3-diylbis(methylimiomethylene)]di(benzene-1,2-diol);

3,3′-[piperazine-1,4-diylbismethylene)di(benzene-1,2-diol).

Preferably the nitrogen-containing chain linking the two aromatic rings together is attached at either end to each of the aromatic rings in the position ortho to the groups OR₂.

Preferred substituents for R₁-R₄ and Y₁-Y₃ for the compound of this embodiment of the invention are as set out above.

Preferably p is 2 or 3. Preferably R₁₀ and R₁₁ are each H.

Preferably R₈ and R₉ are independently a straight chained or branched C₁-C₁₀ alkyl group, a C₄-C₁₀ cyclic alkyl group or together form a straight chained, branched or cyclic alkyl group linking the two nitrogen atoms together. More preferably, R₈ and R₉ are independently selected from the group consisting of methyl, ethyl, propyl, butyl, pentyl, hexyl, octyl, and decyl, including the isomers thereof.

Examples of compounds within this class are as follows:

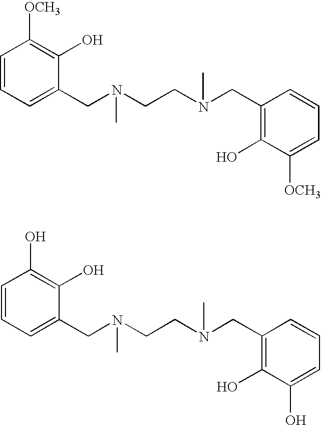

According to another embodiment of the present invention, there is provided a polymer having the following formula:

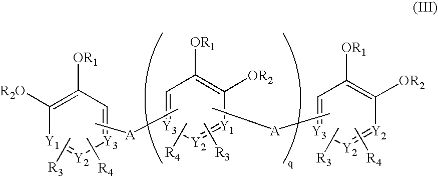

wherein:

q is a positive integer;

A is the following structure:

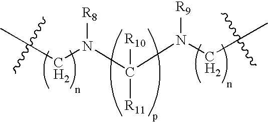

R₁ and R₂ are independently H, optionally substituted alkyl, alkenyl alkynyl or aryl, or an oxygen protecting group;

R₃ is H, an optionally substituted alkyl, alkenyl, alkynyl or aryl, or an optionally substituted carbocyclic, heterocyclic, aromatic or heteroaromatic ring, or series of rings, fused to the respective ring or rings represented above;

R₄ is H, —OR₅ or any other non-deleterious substituent;

R₅ is H or an optionally substituted alkyl, alkenyl, alkynyl or aryl;

Y₁, Y₂ and Y₃ are each independently CH or N;

n is 0 or a positive integer;

p is a positive integer;

R₈ and R₉ are the same or different, and are each an optionally substituted straight chained, branched or cyclic alkyl group, or R₈ and R₉ may together form a substituted or unsubstituted, straight chained, branched or cyclic alkyl group linking the two nitrogen atoms; and

R₁₀ and R₁₁ are the same or different, and are each H or a substituted or unsubstituted branched or straight chained alkyl group;

and wherein the polymer may contain cross-linking through R₈ and/or R₉.

The polymer preferably has an average molecular weight of between 330 and 15,000, and more preferably between 330 and 10,000.

Preferably q is a positive integer from 1 to 4.

These polymers can be formed by a Mannich condensation of the appropriate diamines, aldehydes and catechol-based reagents. By controlling the reagent ratios, polymeric structures can be formed. These polymeric structures can also be formed from Mannich condensation of monoalkyl ethers of the appropriate catechol-based reagents, aldehydes and diamines. The reaction product of the monoalkyl ether reagents can then be isolated and optionally deprotected and condensed further to form the polymer. Cross-linked versions of the polymers can be made by selecting the appropriate mix of primary and secondary diamines.

According to another embodiment of the invention, there is provided an ion exchange resin of the following structure:

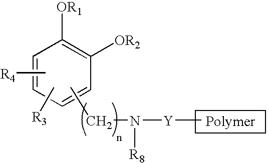

wherein;

R₁, R₂, R₃, R4, R8 and n are as defined above; and

Y is a direct bond or a divalent linking group, such as a straight chain or branched alkyl group.

The preferred substituents for R₁, R₂, R₃ and R₄ are as outlined above.

Preferably R₈ is a straight-chained alkyl group having a chain length of from 1 to 4 carbon atoms. Preferably Y is a straight-chained alkyl group having a chain length of from 1 to 5 carbon atoms.

The groups pendant to the polymer backbone are selected so as to be capable of selectively chelating target cations from an aqueous solution.

The polymer may be of any suitable type commonly used in forming ion exchange resins, such as polystyrene.

According to the present invention there is also provided a complex of a cation and a ligand, compound, polymer or ion exchange resin, the ligand, compound, polymer or ion exchange resin being as defined above.

The cation may be any of the metal cations, or may be one of the metal-like cations silicon, boron, germanium, arsenic and selenium.

Preferably the cation is selected from the group consisting of silicon, boron, aluminium, titanium, copper, gold, lead, tin, zinc, gallium, germanium, vanadium, chromium, manganese, iron, cobalt, nickel, zirconium, hafnium, niobium, tantalum, molybdenum, tungsten, technetium, rhenium, platinum, ruthenium, osmium rhodium, iridium, palladium, platinum, silver, indium and thallium. More preferably the cation is selected from the group consisting of silicon, boron, aluminium, titanium, copper and gold. In some applications of the invention, particularly suited cations are silicon (eg Si⁴⁺), aluminium (eg Al³⁺), titanium, gold and copper.

The present invention also provides a method for extracting target cations from an aqueous solution comprising:

contacting a solution containing the target cations with a complexing ligand, compound, polymer or ion exchange resin as described above;

forming a complex of the complexing ligand, compound, polymer or ion exchange resin and the target cations; and

separating the aqueous solution from the complex.

The ligands of the present invention are recyclable in this process. Accordingly, the method preferably includes the step of separating the target cations from the complexing ligand, compound polymer or ion exchange resin, and reusing the ligand, compound, polymer or ion exchange resin for separating further target cations.

Preferred target cations are as described above. It will be understood that in certain minerals processing operations it is desirable to selectively extract certain cations to the exclusion, or substantial exclusion, of others in an aqueous solution. Cations of particular interest in this regard are aluminium, silicon, titanium, boron, gallium, germanium, indium, tin, lead, uranium, gold, silver, arsenic, selenium, cadmium, mercury, chromium, copper and iron.

It is preferred that the ligand be in the form of the simple compound, bis compound or organic solvent-soluble polymer described above, as this would enable current extraction circuit technology to be employed to extract the target cations from other cations. In this situation, the separation step comprises extracting the complex into an organic phase, and separating the organic phase from the aqueous phase. In the alternative, when a solid-phase ion exchange resin is used, the separation step comprises physically separating the exchange resin from the aqueous solution.

The present invention also provides a method for the selective separation of silicon and aluminium in an aqueous liquor containing dissolved silica and alumina (such as a Bayer process liquor), the method comprising:

contacting said liquor with the ligand, compound, polymer or ion exchange resin described above;

forming a complex of the ligand, compound, polymer or ion exchange resin with the either the silicon ions or the aluminium ions;

separating the complex from the liquor.

The applicant has found that in certain ligands of the present invention, aluminium ions are complexed in preference to silicon ions. Accordingly, the ligand, compound, polymer or ion exchange resin preferably forms a complex with the aluminium ions.

Preferably the ligand is separated from aluminium ions, and the ligand is reused for the separation of further cations.

### DETAILED DESCRIPTION OF THE INVENTION

Before the background leading up to the invention is described in further detail, we set out below some definitions of terms used in the specification and claims to assist in interpretation.

The term “amine” used either alone or in a compound word is used in this specification in its broadest sense. It includes within its scope any group that includes an amino nitrogen atom which is basic in nature. In includes amino, alkylamino (for example methylamino), dialkylamino (for example dimethylamino or methylethylamino), aminoalkylene (for example aminomethylene (—CH₂NRₓR_{y} or aminoethylene), aminoalkenylene, aminoalkenylene and so forth. It is not intended to cover amido substituents, which are not basic in nature.

The term “alkyl” used either alone or in a compound word such as “optionally substituted alkyl” or “optionally substituted cycloalkyl” denotes straight chain, branched or mono- or poly-cyclic alkyl, preferably C1-30 alkyl or cycloalkyl. Examples of straight chain and branched alkyl include methyl, ethyl, propyl, isopropyl, butyl, isobutyl, sec-butyl, tert-butyl, amyl, isoamyl, sec-amyl, 1,2-dimethylpropyl, 1,1-dimethylpropyl, hexyl, 4-methylpentyl, 1-methylpentyl, 2-methylpentyl, 3-methylpentyl, 1,1-dimethylbutyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, 5-methylhexyl, 1-methylhexyl, 2,2-dimethylpentyl, 3,3-dimethylpentyl, 4,4-dimetylpentyl, 1,2-dimethylpentyl, 1,3-dimethylpentyl, 1,4-dimethylpentyl, 1,2,3-trimethylbutyl, 1,1,2-trimethylbutyl, nonyl, 1-, 2-, 3-, 4-, 5-, 6- or 7-methyloctyl, 1-, 2-, 3-, 4- or 5-ethylheptyl, 1-, 2- or 3-propylhexyl, decyl, 1-, 2-, 3-, 4-, 5-, 6-, 7- and 8-methylnonyl, 1-, 2-, 3-, 4-, 5- or 6-ethyloctyl, 1-, 2-, 3- or 4-propylheptyl, undecyl, 1-, 2-, 3-, 4-, 5-, 6-, 7-, 8- or 9-methyldecyl, 1-, 2-, 3-, 4-, 5-, 6- or 7-ethylnonyl, 1-, 2-, 3-, 4- or 5-propyloctyl, 1-, 2- or 3-butylheptyl, 1-pentylhexyl, dodecyl, 1-, 2-, 3-, 4-, 5-, 6-, 7-, 8-, 9- or 10-methylundecyl, 1-, 2-, 3-, 4-, 5-, 6-, 7- or 8-ethyldecyl, 1-, 2-, 3-, 4-, 5- or 6-propylnonyl, 1-, 2-, 3- or 4-butyloctyl, 1-2-pentylheptyl and the like. Examples of cyclic alkyl include cyclopropyl, cyclobutyl, cyclopentyl, cyclohexyl, cycloheptyl, cyclooctyl, cyclononyl and cyclodecyl and the like. The alkyl may optionally be substituted by any non-deleterious substituent.

The term “alkenyl” used either alone or in compound words such as “alkenyloxy” denotes groups formed from straight chain, branched or cyclic alkenes including ethylenically mono-, di- or poly-unsaturated alkyl or cycloalkyl groups as defined above, preferably C2-20 alkenyl. Examples of alkenyl include vinyl, allyl, 1-methylvinyl, butenyl, iso-butenyl, 3-methyl-2-butenyl, 1-pentenyl, cyclopentenyl, 1-methyl-cyclopentenyl, 1-hexenyl, 3-hexenyl, cyclohexenyl, 1-heptenyl, 3-heptenyl, 1-octenyl, cyclooctenyl, 1-nonenyl, 2-nonenyl, 3-nonenyl, 1-decenyl, 3-decenyl 1,3-butadienyl, 1,4-pentadienyl, 1,3-cyclopentadienyl, 1,3-hexadienyl, 1,4-hexadienyl, 1,3-cyclohexadienyl, 1,4-cyclohexaidenyl, 1,3-cycloheptadienyl, 1,3,5-cycloheptatrienyl and 1,3,5,7-cyclooctatetraenyl.

The term “aryl” used either alone or in compound words such as “optionally substituted aryl”, “optionally substituted aryloxy” or “optionally substituted heteroaryl” denotes single, polynuclear, conjugated and fused residues of aromatic hydrocarbons or aromatic heterocyclic ring systems. Examples of aryl include phenyl, biphenyl, terphenyl, quaterphenyl, phenoxyphenyl, naphtyl, tetrahydronaphthyl, anthracenyl, dihydroanthracenyl, benzanthracenyl, dibenzanthracenyl, phenanthrenyl, fluorenyl, pyrenyl, indenyl, azulenyl, chrysenyl, pyridyl, 4-phenylpyridyl, 3-phenylpyridyl, thienyl, furyl, pyrryl, pyrrolyl, furanyl, imadazolyl, pyrrolydinyl, pyridinyl, piperidinyl, indolyl, pyridazinyl, pyrazolyl, pyrazinyl, thiazolyl, pyrimidinyl, quinolinyl, isoquinolinyl, benzofuranyl, benzothienyl, purinyl, quinazolinyl, phenazinyl, acridinyl, benzoxazolyl, benzothiazolyl and the like. Preferably, the aromatic heterocyclic ring system contains 1 to 4 heteroatoms independently selected from N, O and S and containing up to 9 carbon atoms in the ring.

The term “heterocyclyl” used either alone or in compound words such as “optionally substituted saturated or unsaturated heterocyclyl” denotes monocyclic or polycyclic heterocyclyl groups containing at least one heteroatom atom selected from nitrogen, sulphur and oxygen. Suitable heterocyclyl groups include N-containing heterocyclic groups, such as unsaturated 3 to 6 membered heteromonocyclic groups containing 1 to 4 nitrogen atoms, for example, pyrrolyl, pyrrolinyl, imidazolyl, pyrazolyl, pyridyl, pyrimidinyl, pyrazinyl, pyridazinyl, triazolyl or tetrazolyl;

saturated 3 to 6-membered heteromonocyclic groups containing 1 to 4 nitrogen atoms, such as, pyrrolidinyl, imidazolidinyl, piperidino or piperazinyl;

unsaturated condensed heterocyclic groups containing 1 to 5 nitrogen atoms, such as indolyl, isoindolyl, indolizinyl, benzimidazolyl, quinolyl, isoquinolyl, indazolyl, benzotriazolyl or tetrazolopyridazinyl;

unsaturated 3 to 6-membered heteromonocyclic groups containing an oxygen atom, such as, pyranyl or furyl;

unsaturated 3 to 6-membered heteromonocyclic groups containing 1 to 2 sulphur atoms, such as, thienyl;

unsaturated 3 to 6-membered heteromonocyclic groups containing 1 to 2 oxygen atoms and 1 to 3 nitrogen atoms, such as, oxazolyl, isoxazolyl or oxadiazolyl;

saturated 3 to 6-membered heteromonocyclic groups containing 1 to 2 oxygen atoms and 1 to 3 nitrogen atoms, such as, morpholinyl;

unsaturated condensed heterocyclic groups containing 1 to 2 oxygen atoms and 1 to 3 nitrogen atoms, such as, benzoxazolyl or benzoxadiazolyl;

unsaturated 3 to 6-membered heteromonocyclic groups containing 1 to 2 sulphur atoms and 1 to 3 nitrogen atoms, such as, thiazolyl or thiadiazolyl;

saturated 3 to 6-membered heteromonocyclic groups containing 1 to 2 sulphur atoms and 1 to 3 nitrogen atoms, such as, thiazolidinyl; and

unsaturated condensed heterocyclic group containing 1 to 2 sulphur atoms and 1 to 3 nitrogen atoms, such as, benzothiazolyl or benzothiadiazolyl.

In this specification “optionally substituted” means that a group may or may not be further substituted with one or more groups selected from alkyl, alkenyl, alkynyl, aryl, halo, haloalkyl, haloalkenyl, haloalkynyl, haloaryl, hydroxy, alkoxy, alkenyloxy, aryloxy, benzyloxy, haloalkoxy, haloalkenyloxy, haloaryloxy, nitro, nitroalkyl, nitroalkenyl, nitroalkynyl, nitroaryl, nitroheterocyclyl, amino, alkylamino, dialkylamino, alkenylamino, alkynylamino, arylamino, diarylamino, benzylamino, dibenzylamino, acyl, alkenylacyl, alkynylacyl, arylacyl, acylamino, diacylamino, acyloxy, alkylsulphonyloxy, arylsulphenyloxy, heterocyclyl, heterocycloxy, heterocyclamino, haloheterocyclyl, alkylsulphenyl, arylsulphenyl, mercapto, alkylthio, benzylthio, acylthio, phosphorus-containing groups, imino, nitrile and the like. A “non-deleterious substituent” refers to any of the substituents outlined above which is less weakly acidic than the hydroxy proton of 4-methoxyphenol (pKₐ 10.2). Such substituents are to be expected not to interfere with the use of the compounds of the invention as a ligand that can form an internal base when complexed with cations. Alternatively, in the case of aromatic compounds containing an optional substituent, the substituent may be selected so that the aromatic ring has certain electronic properties that promote complexation with a particular target cation.

The term “acyl” used either alone or in compound words such as “optionally substituted acyl” or “optionally substituted acyloxy” denotes carbamoyl, aliphatic acyl group and acyl group containing an aromatic ring, which is referred to as aromatic acyl or a heterocyclic ring which is referred to as heterocyclic acyl, preferably C1-30 acyl. Examples of acyl include carbamoyl; straight chain or branched alkanoyl such as formyl, acetyl, propanoyl, butanoyl, 2-methylpropanoyl, pentanoyl, 2,2-dimethylpropanoyl, hexanoyl, heptanoyl, octanoyl, nonanoyl, decanoyl, undecanoyl, dodecanoyl, tridecanoyl, pentadecanoyl, hexadecanoyl, heptadecanoyl, octadecanoyl, nonadecanoyl and icosanoyl; alkoxycarbonyl such as methoxycarbonyl, ethoxycarbonyl, t-butoxycarbonyl, t-pentyloxycarbonyl and heptyloxycarbonyl; cycloalkylcarbonyl such as cyclopropylcarbonyl, cyclobutylcarbonyl, cyclopentylcarbonyl and cyclohexylcarbonyl; alkylsulfonyl such as methylsulfonyl and ethylsulfonyl; alkoxysulfonyl such as methoxysulfonyl and ethoxysulfonyl; aroyl such as benzoyl, toluoyl and naphthoyl; aralkanoyl such as phenylalkanoyl (e.g. phenylacetyl, phenylpropanoyl, phenylbutanoyl, phenylisobutyl, phenylpentanoyl and phenylhexanoyl) and naphthylalkanoyl (e.g. naphthylacetyl, naphthylpropanoyl and naphthylbutanoyl); aralkenoyl such as phenylalkenoyl (e.g. phenylpropenoyl, phenylbutenoyl, phenyhnethacrylyl, phenylpentenoyl and phenylhexenoyl and naphthylalkenoyl (e.g. naphthylpropenoyl, naphthylbutenoyl and naphthylpentenoyl); aralkoxycarbonyl such as phenylalkoxycarbonyl (e.g. benzyloxycarbonyl); aryloxycarbonyl such as phenoxycarbonyl and naphthyloxycarbonyl; aryloxyalkanoyl such as phenoxyacetyl and phenoxypropionyl; arylcarbamoyl such as phenylcarbamoyl; arylthiocarbamoyl such as phenylthiocarbamoyl; arylglyoxyloyl such as phenylglyoxyloyl and naphthylglyoxyloyl; arylsulfonyl such as phenylsulfonyl and naphthylsulfonyl; heterocycliccarbonyl; heterocyclicalkanoyl such as thienylacetyl, thienylpropanoyl, thienylbutanoyl, thienylpentanoyl, thienylhexanoyl, thiazolylacetyl, thiadiazolylacetyl and tetrazolylacetyl; heterocyclicalkenoyl such as heterocyclicpropenoyl, heterocyclicbutenoyl, heterocyclicpentenoyl and heterocyclichexenoyl; and heterocyclicglyoxyloyl such as thiazolylglyoxyloyl and thienylglyoxyloyl.

The major step forward that has led to the invention was the discovery that through novel modifications of catechol, there is a possibility of providing a complexing ligand for various target cations. These can be used to extract the target cations into an organic liquor, analogous to the solvent extraction systems commonly used for copper and uranium. No such system currently exists for either aluminium or silicon in basic liquors. This invention enables one to selectively remove the target cations.

After investigating the possibilities of the process with respect to catechol-based ligands, it was also recognised that similar methodologies could be used to develop other ligands that, whilst not based on catechol, are also capable of including or forming an internal counter ion so that the complex of the target cation and ligand has an overall neutral charge. It is this surprising property of the catechol-based ligands that has opened up the possibility of using solvent extraction or ion exchange systems.

It was found that mildly acidic media could be used to regenerate the free ligand.

The applicants went on to examine the fundamental chemistry of the complexes and from this alternative systems were developed. As part of this work a range of modified catechol-based chemicals was synthesised and their complexing behaviour examined. It was surprisingly found that certain derivatives of catechol can complex the silicon into a neutrally charged species. This was achieved without any external control of the complexes. These neutral complexes open up a range of possibilities for separation of the complexes from the aqueous liquor, which were not previously possible. There is also greater scope for the manipulation of the properties of the complex to modify complexing efficiency, selectivity between cations and simplification of the regeneration step.

In one aspect, the present invention provides a system of selectively removing aluminium ions from basic liquors. This involves a combination of modifying the basic chemicals to give the optimum complexation whilst allowing separation and subsequent regeneration of the complexing agent.

One of the most successful classes of compounds that form complexes with the target cations is the Mannich base derivatives of catechol. Mannich bases have been found to offer the internal neutralization of the complex formed, and therefore greatly improve the ability of the target metal ions to be taken out of the aqueous phase and into an organic phase.

Mannich bases are formed from the reaction of a reactive phenol (1), formaldehyde (2) and an appropriate amine (3) to form (4) (Scheme 1).

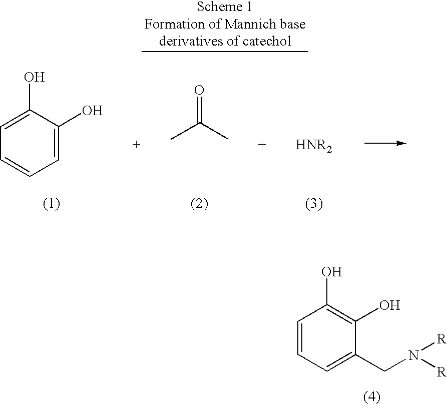

Variation of the R group in the amine can alter the hydrophilic/hydrophobic nature of the Mannich base. This will alter the solubility properties of the phenolic ring, and therefore of the complex formed. The selectivity of these ligands can be altered by the addition of other functional groups to the phenyl ring, thus changing the nature of the ligand.

The present applicants have shown that complexation of the catechol dipropyl Mannich base derivative with Si under controlled conditions, forms the complex (5).

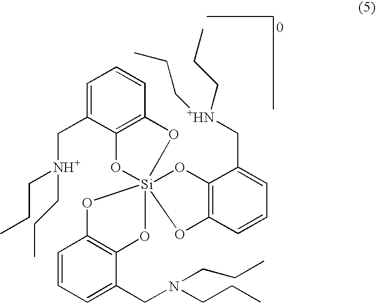

The selective complexation can be controlled by the chemistry of the host liquor, the nature of the ligand, and/or the rate at which the complex is formed. Depending on which metal ion complexes at a greater rate, there is the possibility of selective removal of that ion by careful manipulation of the conditions.

In a further aspect, the present invention provides a method of accomplishing the selective removal of target cations by controlling the rate of decomposition of ligand/metal ion complex.

The system is also applicable to other metal cations for example, but not limited to Ti, Zr, Ga, Ln, Tl, and Mo.

The following embodiments and examples are provided for the purpose of further illustrating the present invention but in no way are to be taken as limiting the present invention.

### EXAMPLE 1

Synthesis of Ligands by Mannich Reaction

The following synthetic procedure describes the application of the Mannich reaction to form various catechol Mannich bases. This methodology uses 2-methoxy phenol (the monomethyl ether of catechol or more commonly named guaiacol), instead of the usual material of catechol. This method has not previously been applied to the synthesis of Mannich bases. The amines that are used in the following procedure are secondary amines. For this reaction to proceed, the amine must be either primary or secondary; a tertiary amine will not undergo this reaction.

General Procedures Applied to the Synthesis of Mannich Base Ligands

The following standard work-up procedure is used for each reaction unless stated otherwise. Upon completion the solvent is removed under reduced pressure followed by acidification with concentrated HCl and ice. The aqueous mixture is washed with diethyl ether (3×20 ml) and neutralized with NaHCO₃. The reaction products are extracted into chloroform (4×20 ml). The organic extracts collected, dried using Na₂SO₄ and concentrated under vacuum. The free catechol Mannich base ligand is obtained by demethylation, via refluxing the methoxy intermediate in a 20% HBr solution in acetic acid.

General Synthetic Method for 2-(dialkylaminomethylene-6-methoxyphenols

The following compounds were synthesized in good yields via the following general method unless stated otherwise. A solution of finely ground paraformaldehyde (0.05 mol, 1 equivalence), appropriate amine (0.10 mol, 2 equivalence) in dry ethanol (10 ml) is added dropwise to a solution of 2-methoxyphenol (0.05 mol, 1 equivalence) at room temperature. After addition is complete the reaction is stirred for 72 h. Standard work-up follows and the products are isolated using standard purification techniques.

The following are examples of a selection of useful synthetic intermediates:

### EXAMPLE 2

2-(Dimethylaminomethylene)-6-methoxyphenol

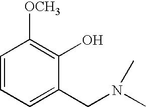

The amine employed for this synthesis is dimethylamine. Column chromatography (acetone) is followed by recrystallization from hot petroleum sprits (40-60° C.) to afford the compound as white grain like crystals (2.97 g 33%), m.p. 4749° C. (Found: C, 66.1; H, 8.3; N, 7.6%. Calc. for C₁₀H₁₅NO₂ C, 66.3; H, 8.3; N, 7.7%). I.r. νₘₐₓ (KBr) 2938, 2834, 1479, 1444, 1266, 1237, 1075 cm⁻¹. ¹H n.m.r. δ 2.35, s, NCH₃; 3.67, s, CH₂N; 3.87, s, OCH₃; 6.61, appr. d, J 7.4 Hz, ArH; 6.74, appr. t, J 7.8 Hz, ArH; 6.81, appr. t, J 8.1 Hz, ArH. ¹³C n.m.r. δ 44.4; 55.8; 62.1; 110.9; 118.5; 120.5; 121.8; 147.3; 147.8. Mass spectrum m/z (e.i.) 181 (100%), 136 (41), 107 (18), 93 (4), 58 (15), 44 (17).

### EXAMPLE 3

2-(Diethylaminomethylene)-6-methoxyphenol

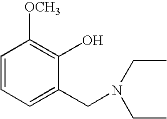

The amine employed for this synthesis is diethylamine. Column chromatography (chloroform) affords the compound as an orange oil (5.79 g, 49%) (Found: C, 68.7; H, 9.2; N, 6.6. C₁₂H₁₉NO₂ requires C, 68.9; H, 9.2; N, 6.7%). I.r. νₘₐₓ (KBr): 2971, 2935, 2831, 1471, 1415, 1250, 1239, 1081 cm⁻¹. ¹H n.m.r. δ 1.09, t, J 7.2 Hz, NCH₂CH₃; 2.60, q, J 7.2 Hz, NCH₂CH₃; 3.75, s, CH₂N; 3.84, s, OCH₃; 6.56, appr. d, J 7.4 Hz, ArH; 6.69, appr. t, J 7.8 Hz, ArH; 6.77, appr. d, J 8.2 Hz, ArH. ¹³C n.m.r. δ 11.1; 46.2; 55.7; 56.7; 110.5; 118.2; 120.2; 122.1; 147.1; 147.8. Mass spectrum m/z (e.i.) 209 (23%), 195 (36), 137 (87), 107 (16), 72 (21), 58 (100) (Found: M⁺, 209.14173. C₁₂H₁₉NO₂ requires M⁺, 209.14158).

### EXAMPLE 4

2-(Dipropylaminomethylene)-6-methoxyphenol

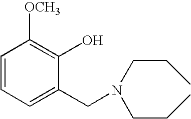

The amine employed for this synthesis is dipropylamine. Column chromatography (ethylacetate) affords the compound as a dark orange oil (5.65 g, 51%) (Found: C, 70.8; 20H, 9.9; N, 6.0. C₁₄H₂₃NO₂ requires C, 70.9; H, 9.8; N, 5.9%). I.r. νₘₐₓ (KBr) 2962; 2935, 2874, 2830 1468, 1415, 1249, 1082 cm⁻¹. ¹H n.m.r. 80.88, t, J 7.4 Hz, NCH₂CH₂CH₃; 1.56, m, NCH₂CH₂CH₃; 2.47, m, NCH₂CH₂CH₃; 3.75, s, CH₂N; 3.86, s, OCH₃; 6.57, dd, J 7.5, 1.1 Hz, ArH; 6.71, appr. t, J 7.7 Hz, ArH; 6.79, dd, J 8.0, 1.3 Hz, ArH. ¹³C n.m.r. δ 11.8; 19.4; 55.4; 55.8; 55.1; 110.6; 118.3; 120.3; 122.3; 147.5; 147.9. Mass spectrum m/z (e.i.) 237 (11%), 208 (45), 137 (100), 122 (7), 107 (7), 72 (75) (Found: M⁺, 237.17343. C₁₄H₂₃NO₂ requires M⁺, 237.17288).

### EXAMPLE 5

2-(Dibutylaminomethylene)-6-methoxyphenol

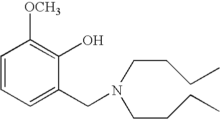

The amine employed for this synthesis is dibutylamine. The reaction is heated at 70° C. for 72 h. Work-up of the reaction gives the crude product as a sticky pale orange residue. The residue is dissolved in a mixture of chloroform: ethylacetate (1:1) and filtered to remove any insoluble residues. The organic filtrate is concentrated under reduced pressure and purified using column chromatography (chloroform) to afford the compound as a dark orange oil (2.10 g, 16%) (Found: C, 72.4; H, 10.2; N, 5.3. C₁₆H₂₇NO₂ requires C, 72.4; H, 10.3; N, 5.3%). I.r. νₘₐₓ (KBr) 2957, 2932, 1588, 1465, 1249, 1081 cm⁻¹. ¹H n.m.r. δ 0.88, t, J 7.2 Hz, NCH₂CH₂CH₂CH₃; 1.30, m, NCH₂CH₂CH₂CH₃; 1.52, m, NCH₂CH₂CH₂CH₃; 2.50, m, NCH₂CH₂CH₂CH₃; 3.75, s, CH₂N; 3.86, s, OCH₃; 6.57, appr. d, J 7.5 Hz, ArH; 6.71, appr. t, J 7.8 Hz, ArH; 6.79, appr. d, J 8.1 Hz, ArH. ¹³C n.m.r. δ 13.9; 20.5; 28.3; 53.12; 6.76; 58.0; 110.6; 118.3; 120.3; 122.2; 147.5; 147.8. Mass spectrum m/z (e.i.) 265 (6%), 222 (38), 137 (80), 122 (4), 107 (10), 86 (100), 65 (33) (Found: M⁺, 265.20350. C₁₆H₂₇NO₂ requires M⁺, 265.20418).

### EXAMPLE 6

General Synthetic Method for 3-(dialkylaminomethylene)catechol Mannich Bases

The following compounds are synthesized in good yields via the following general method unless otherwise stated. A solution of finely ground paraformaldehyde (0.05 mol, 1 equivalence) and the appropriate amine (0.10 mol, 2 equivalence) in dry ethanol (10 ml) is added dropwise to solution of 2-methoxyphenol (0.05 mol, 1 equivalence) in dry ethanol (10 ml) at room temperature. Upon completion of the addition the reaction is stirred for 72 h. A standard work-up follows to give the crude product, which is demethylated via the standard method. After demethylation a second work-up is followed and the products are isolated using standard purification techniques.

The following are examples of a selection of the useful synthetic intermediates catechol Mannich base derivatives:

### EXAMPLE 7

3-(Dimethylaminomethylene)catechol

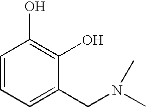

The amine employed for this synthesis is dimethylamine. Column chromatography (ethylacetate) affords the compound as pale orange needle like crystals (2.98 g, 35%), m.p. 67-69° C. (Found: C, 64.7; H, 7.9; N, 8.4. C₉H₁₃NO₂ requires C, 64.7; H, 7.8; N, 8.4%). I.r. νₘₐₓ (KBr) 3401, 1473, 1455, 1256, 1201, 1179 cm⁻¹. ¹H n.m.r. (CD₃OD) δ 2.31, s, NCH₃; 3.62, s, CH₂N; 6.52, dd, J 7.5, 1.4 Hz, ArH; 6.60, appr. t, J7.7 Hz, ArH; 6.70; dd, J 7.9, 1.5 Hz, ArH. ¹³C n.m.r. (CD₃OD) δ 44.8; 62.8; 115.8; 120.1; 121.0; 123.9; 146.4; 146.9. Mass spectrum m/z (e.i.) 167 (100%), 122 (41), 58 (4), 46 (4).

### EXAMPLE 8

3-(Diethylaminomethylene)catechol

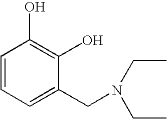

The amine employed for this synthesis is diethylamine. Column chromatography (acetone) affords the compound as pale yellow grain like crystals (5.33 g, 55%) m.p. 43-44° C. (Found: C, 67.6; H, 8.6; N, 7.1. Calc. for C₁H₁₇NO₂ C, 67.7; H, 8.8; N, 7.2%). I.r. νₘₐₓ (KBr) 3436, 2975, 1475, 1261, 1181 cm⁻¹. ¹H n.m.r. δ 1.13, t, J 7.2 Hz, NCH₂CH₃; 2.65, q, J 7.1 Hz, NCH₂CH₃; 3.78, s, CH₂N; 6.52, appr. d, J 7.5 Hz, ArH; 6.67, appr. t, J 7.8 Hz, ArH; 6.84, dd, J 7.9, 1.3 Hz, ArH; 8.69 ArOH. ¹³C n.m.r δ 11.0; 46.3; 56.2; 113.7; 119.0; 119.5; 121.3; 144.8; 145.1. Mass spectrum m/z (e.i.) 195 (53%), 166 (2), 137 (4), 123 (45), 72 (19), 58 (100).

### EXAMPLE 9

3-(Dipropylaminomethylene)catechol

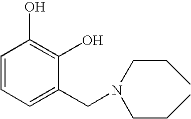

The amine employed for this synthesis is dipropylamine. Column chromatography (ethylacetate) affords the compound as pale yellow needle like crystals (3.84 g, 34%) m.p. 34-35° C. (Found: C, 69.7; H, 9.6; N, 6.4. Calc. for C₁₃H₂₁NO₂ C, 69.9; H, 9.5; N, 6.3%). I.r. νₘₐₓ (KBr) 3451, 2965, 2940, 1477, 1470, 1361, 1259, 1180 cm⁻¹. ¹H n.m.r. (CD₃OD) δ 0.80, J 7.4 Hz, NCH₂CH₂CH₃; 1.92, m, NCH₂CH₂CH₃; 2.38, m, NCH₂CH₂CH₃; 3.64, s, CH₂N; 6.38, dd, J 7.5, 1.1 Hz, ArH; 6.48 appr. t, J 7.7 Hz, ArH; 6.60, dd, J 7.9, 1.5 Hz, ArH. ¹³C n.m.r. (CD₃OD) δ 12.2; 20.7; 56.7; 59.0; 115.7; 120.1; 120.6; 124.2; 146.3; 147.0. Mass spectrum m/z (e.i.) 223 (9%), 194 (12), 122 (24), 72 (100), 43 (20).

### EXAMPLE 10

3-(Dibutylaminomethylene)catechol

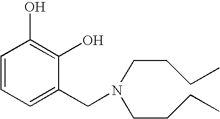

The amine employed for this synthesis is dibutylamine. The reaction is heated to 70° C. and stirred for 72 h Column chromatography (acetone) affords the product as a yellow oil (3.05 g, 24%) (Found: C, 71.6; H, 10.1; N, 5.5. C₁₅H₂₅NO₂ requires C, 71.7; H, 10.0; N, 5.6%). I.r. νₘₐₓ (KBr) 2958, 2933, 2872, 1471, 1364, 1286, 1256, 1189 cm⁻¹. ¹H n.m.r. δ 0.91, J 7.4 Hz, NCH₂CH₂CH₂CH₃; 1.30, m, NCH₂CH₂CH₂CH₃; 1.52, m, NCH₂CH₂CH₂CH₃; 2.52, m, NCH₂CH₂CH₂CH₃; 3.76, s, —CH₂N; 6.51, appr. d, J 7.5 Hz, ArH; 6.67, appr. t, J 7.7 Hz, Ar H; 6.83, appr. d, J 8.1 Hz, ArH. ¹³C n.m.r. δ 13.8; 20.4; 28.2; 53.0; 57.7; 113.4; 118.8; 119.1; 121.7; 144.5; 145.0. Mass spectrum m/z (e.i) 252 (100%), 208 (46), 123 (26) (Found: M⁺, 251.18919. C₁₅H₂₅NO₂ requires M⁺, 251.18853).

### EXAMPLE 11

General Synthetic Method for 6,6′-dimethoxy-2,2′-[alkylenebis(alkyliminomethyene)]diphenols

The following compounds are prepared in good yields via the application of the following general method. A solution of finely ground paraformaldehyde (0.05 mol, 1 equivalence) and the appropriate amine (0.05 mol, 1 equivalence) in dry ethanol (10 ml) is added dropwise to a solution of 2-methoxyphenol (0.025 mol, 0.5 equivalence) in dry ethanol (10 ml) at room temperature. Upon completion of the addition the reaction is heated to 40° C. and stirred for a further 4 days. A standard work-up follows and the products are isolated using standard purification techniques.

The following are examples of useful bis intermediate compounds.

### EXAMPLE 12

6,6′-Dimethoxy-2,2′-[ethylenebis(methyliminomethylene)]diphenol

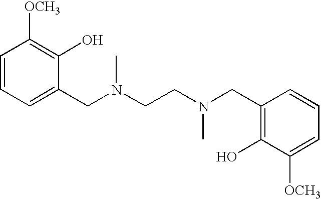

The amine employed for this synthesis is N,N′-dimethyethylenediamnie. Recrystallization of the crude twice from hot ethanol affords the compound as white crystals (3.40 g, 38%), m.p. 115-116° C. (Found: C, 66.5; H, 7.9; N, 7.3. C₂₀H₂₈N₂O₄ requires C, 66.6; H, 7.8; N, 7.7%). I.r. νₘₐₓ (KBr) 2846, 2362, 1480, 1465, 1252, 1239 cm⁻¹. ¹H n.m.r. δ 2.30, s, NCH₃; 2.70, s, NCH₂CH₂N; 3.70, s, NCH₂; 3.86, s, OCH₃; 6.57, appr. d, J 7.3 Hz, ArH; 6.73, appr. t, J 7.7 Hz, ArH; 6.79, appr. d, J 7.2 Hz, ArH. ¹³C n.m.r. δ 41.8; 54.4; 55.8; 61.3; 111.1; 118.8; 120.5; 121.8; 146.9; 147.9. Mass spectrum (e.i.) m/z 360 (3%), 180 (100), 137 (83), 107 (14) 44 (64) (Found: M⁺, 360.20356. C₂₀H₂₈N₂O₄ requires M⁺, 360.20491).

### EXAMPLE 13

6,6′-Dimethoxy-2,2′-[ethylenebis(ethyliminomethylene)]diphenol

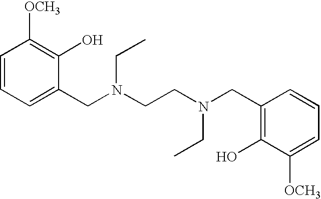

The amine employed for this synthesis is N,N′-diethylethylenediamine. Column chromatography (chloroform) affords the compound as pale yellow crystals (2.96 g, 41%), m.p. 71-72° C. (Found: C, 68.0; H, 8.3; N, 7.2. C₂₂H₃₂N₂O₄ requires C, 68.0; H, 8.3; N, 7.2%). I.r. νₘₐₓ (KBr) 2979, 2834, 1468, 1251, 1232, 1064 cm⁻¹. ¹H n.m.r. δ 1.07, t, J 7.1 Hz, NCH₂CH₃; 2.59, q, J 7.2 Hz, NCH₂CH₃; 2.79, s, NCH₂CH₂N; 3.74, s, NCH₂; 3.86, s, OCH₃; 6.56, appr. d, J 7.5 Hz, ArH; 6.71, appr. t, J 7.5 Hz, ArH; 6.79, dd, J 8.1, 1.4 Hz, ArH. ¹³C n.m.r. δ 11.2; 47.9; 50.6; 55.9; 57.7; 111.0; 118.7; 120.5; 121.9; 147.2; 147.9. Mass spectrum m/z (e.i.) 388 (14%), 251 (2), 194 (96), 137 (100), 122 (4), 107 (12), 58 (84), 39 (11) (Found: M⁺, 388.23551. C₂₂H₃₂N₂O₄ requires M⁺, 388.23621).

### EXAMPLE 14

6,6′-Dimethoxy-2,2′-[propane-1,3-diylbis(methyliminomethylene)]diphenol

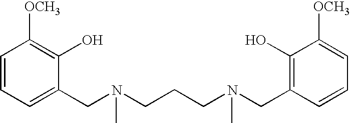

The amine employed for this synthesis is N,N′-dimethyl-1,3-propanediamine. Column chromatography (ethyl acetate) affords the compound as orange crystals (2.48 g, 40%), m.p. 78-79° C. (Found: C, 67.3; H, 8.1; N, 7.5. C₂₁H₃₀N₂O₄ requires C, 67.4; H, 8.1; N, 7.5%). I.r. νₘₐₓ (KBr) 2961, 2837, 1478, 1456, 1251, 1238 cm⁻¹. ¹H n.m.r. δ 1.87, quin, J 7.1 Hz, NCH₂CH₂CH₂N; 2.27, s, NCH₃; 2.55, t, J 7.4 Hz, NCH₂CH₂CH₂N; 3.70, s, NCH₂; 3.87, s, OCH₃; 6.58, dd, J 7.4, 1.0 Hz, ArH; 6.73, appr. t, J 7.8 Hz, ArH; 6.80, dd, J 8.1, 1.4 Hz, ArH. ¹³C n.m.r. δ 24.7; 41.2; 54.9; 55.8; 61.2; 110.9; 118.7; 120.5; 121.8; 147.1; 147.8. Mass spectrum m/z (e.i.) 374 (5%), 207 (11), 186 (36), 166 (30), 150 (5), 137 (100), 101 (26), 58 (30) (Found: M⁺, 374.22059. C₂₁ H₃₀N₂O₄ requires M⁺, 374.22056).

### EXAMPLE 15

6,6′-Dimethoxy-2,2′-(piperazine-1,4-diylbismethylene)diphenol

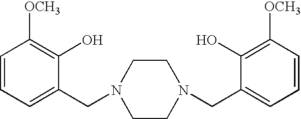

The amine employed for this synthesis is piperazine. Column chromatography (chloroform) is followed by recrystallization from hot ethanol to afford the compound as white needle like crystals (1.84 g, 31%), m.p. 197-198° C. (Found: C, 67.1; H, 7.3; N, 7.9. Calc. for C₂₀H₂₆N₂O₄ C, 67.0; H, 7.3; N, 7.8%). I.r. νₘₐₓ (KBr) 2945, 2830, 1460, 1257, 1239 cm⁻¹. ¹H n.m.r. δ 2.37, br s, ring CHaHbCHaCHb; 2.93, br s, ring CHaHbCHaCHb; 3.72, s, NCH₂; 3.87, s, OCH₃; 6.60, appr. d, J 7.4 Hz, ArH; 6.75, appr. t, J 7.8 Hz, ArH; 6.81, appr. d, J 7.6 Hz, ArH. ¹³C n.m.r. δ 52.3; 55.8; 60.9; 111.1; 118.9; 120.7; 121.0; 146.8; 147.9. Mass spectrum m/z (e.i.) 358 (30%), 221 (61), 180 (29), 137 (100), 122 (9), 85 (36).

### EXAMPLE 16

General Synthetic Method for 3,3′-[alkanebis(methyliminomethylene)]di(catechol) Mannich Bases

The following compounds are obtained in excellent yields by the demethylation of the corresponding 6,6′-dimethoxy-2,2′-[alkylenebis(alkylimiomethylene)]diphenol intermediates. After demethylation using the standard procedure is complete a standard work-up follows and isolation of the products are achieved by standard purification techniques.

### EXAMPLE 17

3,3′-[Ethylenebis(methyliminomethylene)]di(catechol)

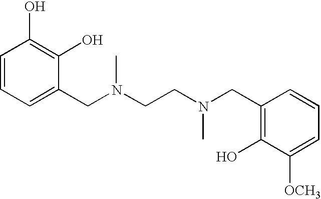

Column chromatography (ethyl acetate) affords the compound as pale yellow crystals (1.16 g, 96%), m.p. 91-92° C. (Found: C, 65.0; H, 7.3; N, 8.5. C₁₈H₂₄N₂O₄ requires C, 65.0; H, 7.3; N, 8.4%). I.r. νₘₐₓ (KBr) 3450, 3394, 1480, 1463, 1265, 1189 cm⁻¹. ¹H n.m.r. δ 2.27, s, NCH₃; 2.65, s, NCH₂CH₂N; 3.68, s, NCH₂; 6.51, appr. d, J 7.6 Hz, ArH; 6.69, appr. t, J 7.8 Hz, ArH; 6.85, appr. d, J8.1 Hz, ArH. ¹³C n.m.r. δ 41.5; 53.7; 61.3; 114.2; 119.5; 119.5; 121.5; 144.4; 144.8. Mass spectrum m/z (e.i.) 332 (4%), 166 (72), 122 (67), 94 (12), 66 (14), 44 (100) (Found: M⁺, 332.17248. C₁₈H₂₄N₂O₄ M⁺, requires 332.17361).

### EXAMPLE 18

3,3′-[Ethylenebis(ethyliminomethylene)]di(catechol)

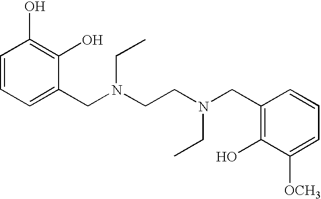

The crude product mixture is dissolved in acetone and passed through a plug of silica to afford the compound as pale yellow crystals (1.61 g, 87%), m.p. 143-144° C. (Found: C, 66.7; H, 7.6; N, 8.0. C₂₀H₂₈N₂O₄ requires C, 66.6; H, 7.8; N; 7.8%). I.r. νₘₐₓ (KBr) 3451, 2979, 1482, 1468, 1373, 1289, 1258, 1189 cm⁻¹. ¹H n.m.r. δ 1.10,s, t, J 7.2 Hz, NCH₂CH₃; 2.57, q, J 7.2 Hz NCH₂CH₃; 2.70, s, NCH₂CH₂N; 3.73, s, NCH₂; 6.50, appr. d, J 7.5 Hz, ArH; 6.69, appr. t, J 7.7 Hz, ArH; 6.84, appr. d, J 7.9 Hz, ArH. ¹³C n.m.r. δ 10.9; 47.5; 50.1; 57.3; 113.9; 119.5; 119.5; 121.4; 144.5; 144.7. Mass spectrum m/z (e.i.) 360 (11%), 238 (12), 194 (4), 166 (9), 122 (83), 94 (55), 58 (100) (Found: M⁺, 360.20518. C₂₀H₂₈N₂O₄ requires M⁺, 360.20491).

### EXAMPLE 19

3,3′-[Propane-1,3-diylbis(methyliminomethylene)]di(catechol)

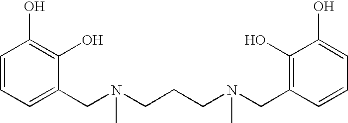

The crude product is dissolved in a mixture of acetone:chloroform (1:1) and followed by filtration to remove any insoluble residues. The organic filtrate is collected and concentrated under reduced pressure. Column chromatography (acetone) affords the compound as pale yellow crystals (1.73 g, 87%), m.p. 130° C. (dec.) (Found: C, 66.0; H, 7.9; N, 7.6. C₁₉H₂₆N₂O₄ requires C, 65.9; H, 7.6; N, 8.0%). I.r. νₘₐₓ (KBr) 3412, 3051, 2962, 2846, 1475, 1354, 1196 cm⁻¹. ¹H n.m.r. δ 1.83, quin, NCH₂CH₂CH₂N; 2.31, s, NCH₃; 2.52, t, J 7.5 Hz, NCH₂CH₂CH₂N; 3.70, s, NCH₂; 6.51, appr. d, J 7.6 Hz, ArH; 6.69, appr. t, J 7.7 Hz, ArH; 6.84, appr. d, J 7.9 Hz, ArH. ¹³C n.m.r. δ 24.6; 41.4; 54.6; 61.1; 113.8; 119.3; 119.4; 121.3; 144.6; 144.6. Mass spectrum m/z (e.i.) 346 (12%), 224 (24), 193 (13), 166 (28), 152 (28), 122 (100), 94 (25), 71 (54), 58 (40) (Found: M⁺, 346.18902. C₁₉H₂₆N₂O₄ requires M⁺, 346.18926).

### EXAMPLE 20

3,3′-(Piperazine-1,4-diylbismethylene)di(catechol)

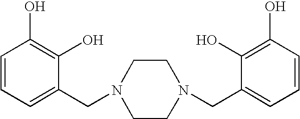

Column chromatography (chloroform) affords the compound as pale yellow crystals (0.91 g, 90%), m.p. 210° C. (dec.) (Found: C, 65.4; H, 6.8; N, 8.4. C₁₈H₂₂N₂O₄ requires C, 65.4; H, 6.7; N, 8.5%). I.r. νₘₐₓ (KBr) 3517, 2935, 2831, 1483, 1347, 1268, 1242, 1170 cm⁻¹. ¹H n.m.r. δ 2.35, br s, ring CHaHbCHaCHb; 2.95, br s, ring CHaHbCHaCHb; 3.75, s, NCH₂; 6.53, appr. d, J 7.4 Hz, ArH; 6.71, appr. t, J 7.8 Hz, ArH; 6.85, dd, J 8.0, 1.3 Hz, ArH. ¹³C n.m.r. δ 52.4; 60.8; 114.1; 119.7; 119.7; 120.5; 144.1; 144.5. Mass spectrum m/z (e.i.) 330 (20%), 166 (54), 122 (89), 85 (80), 56 (57), 44 (100) (Found: M⁺, 330.15705. C₁H₂₂N₂O₄ requires M⁺, 330.15796).

### EXAMPLE 21

Polymers

In addition to the monomeric compounds by varying the ratio on formaldehyde, diamine and catechol (or guaiacol), polymers of theses Mannich base adducts can be formed. One can also form a novolac type resin from condensation of formaldehyde and Mannich base units.

### EXAMPLE 22

Silicon Complexes

These Mannich bases can be used to form new tris complexes with silicon (example of the structure shown below), that forms an internal salt (a self-neutralizing complex that does not require an external counter ion).

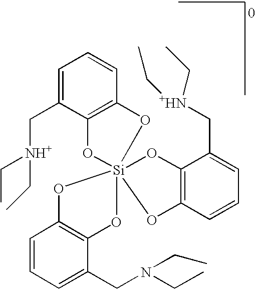

### EXAMPLE 23

General Synthetic Method for Si-Ligand Complexes

Preparations of silicon and Mannich base ligand complexes are performed with careful exclusion of moisture using dry solvents. The complexes are synthesized using the following general procedure unless otherwise stated. To a dry round bottom flask, a solution of ethanol (10 ml) and complexing ligand (60 mmol, 3 molar equivalence) is stirred for 10 minutes. To this solution, tetraethyl orthosilicate (20 mmol, 1 molar equivalence) is added and stirred overnight. The complexes precipitate from the ethanol solvent. The complexes are recovered by filtration, washed with diethyl ether and dried under vacuum. The tris-complex is formed regardless of the initial ratios of each of the reagents used, more importantly the same type of complex fomes in the presence of the bare triethylamine (TEA), albeit at a faster rate. The two protons are delocalized on the three basic nitrogen atoms. The same method is applicable to the synthesis of other Mannich base complexes with silicon.

### EXAMPLE 24

[3-(Dimethylaminomethylene)catecholato(2-)]bis [3-(dimethylammonio-methylene)catecholato (2-)silicate(IV)

The complex is an off white powder (0.30 g, 48%), m.p. 175-180° C. (dec.) (Found: C, 61.6; H, 6.7; N, 7.9. C₂₇H₃₅N₃O₆Si requires C, 61.2; H, 6.7; N, 7.6%). I.r. νₘₐₓ (KBr) 2954, 2816, 2773, 1478 and 1245 cm⁻¹. ¹H n.m.r. δ (D₂O) 2.58, m, 18H, N(CH₃)₂; 3.98, m, ArCH₂N(CH₃)₂ and 6.65, m, 9H, ArH. ¹³C n.m.r. δ (D₂O) 45.2-45.4, N(CH₃)₂; 59.7-61.7, CH₂N(CH₃)₂; 114.3-123.5 and 151.9-152.3. Mass spectrum (ESI⁺) m/z 526 ([M+H]⁺, 72%), 481 (42), 436 (52), 391 (25), 359 (8), 346 (46), 301 (100), 167 (2) and (ESI⁻) m/z 524 ([M−H]⁻, 70%).

### EXAMPLE 25

[3-(Diethylaminomethylene)catecholato (2-)]bis[3-(diethylammonio-methylene)catecholato (2-)silicate(IV)

The complex is a white powder (0.76 g, 73%), m.p. 182-186° C. (dec.) (Found: C, 64.6; H, 7.9; N, 6.7. C₃₃H₄₇N₃O₆Si requires C, 65.0; H, 7.8; N, 6.9%). I.r. νₘₐₓ (KBr) 3047, 3028, 2971, 2800, 1479s and 1262s cm⁻¹. ¹H n.m.r. δ (D₂O) 1.15, m, 18H, N(CH₂CH₃)₂; 2.92, m, 12H, N(CH₂CH₃)₂; 4.01, m, 6H, ArCH₂N(CH₂CH₃)₂ and 6.65, m, 9H, ArH. ¹³C n.m.r. δ (D20) 10.9-11.6, N(CH₂CH₃)₂; 49.0-49.3, N(CH₂CH₃)₂; 54.7-57.2, ArCH₂N(CH₂CH₃)₂; 114.4-123.5 and 152.1-152.6. Mass spectrum (ESI⁺) m/z 610 ([M+H]⁺, 67%) 537 (100), 464 (77), 391 (9) and (ESI⁻) m/z 608 ([M−H]⁻, 100%).

### EXAMPLE 26

[3-(Dipropylaminomethylene)catecholato (2-)]bis[3-(dipropylammonio-methylene)catecholato (2-)silicate(V)

The complex is a white powder (0.58 g, 49%), m.p. 184-190° C. (dec.) (Found: C, 67.6; H, 8.7; N, 6.0. C₃₉H₅₉N₃O₆Si requires C, 67.5; H, 8.6; N, 6.1%). I.r. νₘₐₓ (KBr) 3043, 2964, 2876, 2804, 1585, 1476s and 1256s cm⁻¹. ¹H n.m.r. δ (CD₃OD) 0.84, m, 18H, N(CH₂CH₂CH₃)₂; 1.60, m, 12H, N(CH₂CH₂CH₃)₂; 2.74, m, 12H, N(CH₂CH₂CH₃)₂; 3.98, m, 6H, ArCH₂N(CH₂CH₂CH₃)₂ and 6.57, m, 9H, ArH. ¹³C n.m.r. δ (CD₃OD) 11.5-12.3, N(CH₂CH₂CH₃)₂; 18.4-20.8, N(CH₂CH₂CH₃)₂; 54.5-58.9, ArCH₂N(CH₂CH₂CH₃)₂; 111.8-120.6 and 151.5-152.6. Mass spectrum (ESI) m/z 695 ([M+H]⁺, 33%), 593 (100), 492 (53), 391 (6), 224 (3) and (ESI⁻) m/z 693 ([M−H]⁻, 47%).

### EXAMPLE 27

[3-(Dibutylaminomethylene)catecholato (2-)]bis[3-(dibutylammonio-methylene)catecholato (2-)silicate(IV)

The complex is a white powder (0.62 g, 56%), m.p. 205-207° C. (dec.) (Found: C, 69.5; H, 9.2; N, 5.4. C₄₅H₁₇N₃O₆Si requires C, 69.0; H, 9.3; N, 5.3%). I.r. νₘₐₓ (KBr) 3016, 2959, 2935, 2877, 1473s and 1258s cm⁻¹. ¹H n.m.r. δ (CD₃OD) 1.01, m, 18H, N(CH₂CH₂CH₂CH₃)₂; 1.32, m, 12H, N(CH₂CH₂CH₂CH₃)₂; 1.58, m, 12H, N(CH₂CH₂CH₂CH₃)₂; 2.85, m, 12H, N(CH₂CH₂CH₂CH₃)₂; 3.97, m, 6H, CH₂N(CH₂CH₂CH₂CH₃)₂ and 6.52, m, 9H, ArH. ¹³C n.m.r. δ (CD₃OD) 14.6-14.8, N(CH₂CH₂CH₂CH₃)₂; 21.6-22.1, N(CH₂CH₂CH₂CH₃)₂; 27.2-30.2, N(CH₂CH₂CH₂CH₃)₂; 54.1-59.3, CH₂N(CH₂CH₂CH₂CH₃)₂; 112.2-121.0 and 152.1-152.4. Mass spectrum (ESI⁺) m/z 779 ([M+H]⁺, 56%), 778 (100), 694 (22), 520 (11) and 391 (1).

### EXAMPLE 28

Synthesis of Silicon(IV) Complexes with di-catechol Mannich Bases

The complexes formed with complex 3,3′-[Ethylenebis(methyliminomethylene)-]di(catechol) and 3,3′-[Propane-1,3-diylbis(methyliminomethylene)] di(catechol) are prepared according to the method described in 2.1 with the substitution of ethanol for tretrahydrofuran (THF). The Mannich base ligand (1.5 mmol) to tetraethyl orthosilicate (1.0 mmol) is adjusted to 1:1.5 respectively. The complexes are large 3-dimenstional network insoluble polymers, wherein both ends on the ligand coordinate to different silicon ions independent of eachother.

### EXAMPLE 29

Silicon(V) Complex with 3,3′-[ethylenebis(methyliminomethylene)-]di(catechol)

The complex is a white powder (0.5 g), m.p. 130° C. (dec.) (Found: C, 60.1; H, 6.1; N, 7.5; Si, 4.8%). ICP-AES Si, 4.5%. I.r. νₘₐₓ (KBr) 3400brw, 3044w, 1478s, 1259, 1064, 1041, 743 and 690 cm⁻¹. ¹³C CP-MAS n.m.r. δ 23.6-55.3, H₂CH₃CN(CH₂)₂NCH₃CH₂; 96.5-119.3, ArCH; 135.9, ArC-OH and 142.2, ArC-O-Si. Solid probe mass spectrum (ei) m/z 61 (4%), 105 (28), 121 (9), 149 (100), 173 (9), 227 (6), 316 (7) and 331 (6).

### EXAMPLE 30

Silicon (V) Complex with 3,3′-[propane-1,3-diylbis(methyliminomethylene)]di(catechol)

The complex is a white powder (0.41 g), m.p. 172° C. (dec.) (Found: C, 54.2; H, 6.5; N, 7.8; Si, 7.2%). ICP-AES Si, 7.1%. I.r. νₘₐₓ (KBr) 3410brw, 3044w, 2959w, 1478s, 1258s, 1064, 1040, 856, 746 and 690 cm⁻¹. ¹³C CP-MAS n.m.r. δ 22.6-57.2, H₂CH₃CN(CH₂)₃NCH₃CH₂; 96.9-118.9, ArCH; 136.9, ArC—OH; and 142.5 ArC—O—Si. Solid probe mass spectrum (ei) m/z 60 (2%), 71 (100), 84 (90), 96 (18), 97 (49), 123 (66), 152 (33), 166 (64), 180 (20), 193 (12) and 346 (33).

### EXAMPLE 31

Aluminium Complexes

The Mannich bases can be used to form new monomeric and polymeric complexes with aluminium (example of the structure shown below), that forms an internal salt (a self-neutralizing complex that does not require an external counter ion). Catechol and aluminium complexes formed under the anhydrous conditions described below also forms new monomeric and polymeric complexes that are isolated as triethylammonium salts.

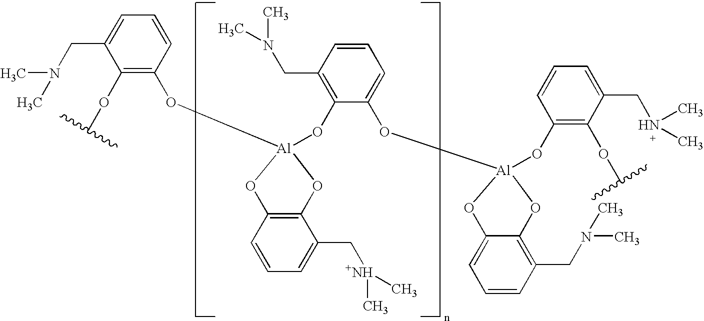

### EXAMPLE 32

General Synthetic Method for Al-Ligand Complex

All preparations of complexes are performed with careful exclusion of moisture using dry solvents and reagents. The aluminium complexes are synthesized in good yields using the following general procedure unless stated otherwise. To a solution of complexing ligand (6.0 mmol, 3 molar equivalence) in sec-butanol (10.0 ml), aluminium tri-sec-butoxide (2.0 mmol, 1 molar equivalence) is added dropwise and the reaction mixture stirred overnight. The complexes precipitate from the sec-butanol solvent. The complexes are recovered by filtration, washed with diethyl ether and dried under vacuum. Elemental analyses for each of the Al(III) complexes is indicative of product mixtures containing monomer, dimer and trimer. An example of the percentage composition is given to indicate correlation with the micro analytical data The type of complexes is not altered by the addition of the base triethylamine.

### EXAMPLE 33

Preparation of Aluminium Complex with Catechol

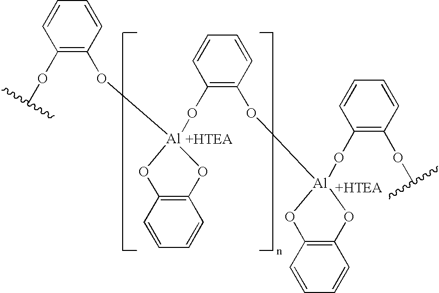

A solution of catechol (1.30 g, 11.8 mmol) in sec-butanol (5.0 ml) is added dropwise to a stirred solution of aluminium tri-sec-butoxide (1.0 ml, 3.92 mmol) and triethylamine (1.36 ml, 11.74 mmol) in sec-butanol (8.0 ml). The reaction is stirred for 3 hours. The complex is obtained as a fine white powder (2.04 g), m.p. 150-155° C. (dec.) (Found: C, 61.7; H, 8.0; N, 4.0%). Gravimetric Al, 5.6%. These values approximate to a mixture containing 16% (1:3:2), 31% (1:3:1), 33% (2:5:2), 12% (3:7:3) and 8% (4:9:4) of aluminium:catechol:TEA respectively, which equates to: C, 60.2; H, 7.1; N, 3.6 and Al, 5.8% I.r. νₘₐₓ (KBr) 3051w, 3028w, 2985w, 1491s and 1251s cm⁻¹. ²⁷Al n.m.r. δ 34.3, br s. ¹H n.m.r. δ 1.27, t, J 7.3 Hz, NCH₂CH₃; 3.19, qt, J 7.3 Hz, NCH₂CH₃; 6.58, br s, ArH; 6.62 and br s, ArH. ¹³C n.m.r. δ 11.1; 49.5; 115.6; 119.8 and 155.9. Mass spectrum 1380 (2%), 1036 (19), 935 (10), 884 (14), 792 (100), 691 (21), 640 (20), 446 (29) and 102 (48).

### EXAMPLE 34

Aluminium Complex with 3-(dimethylaminomethylene)catechol

An off white powder (1.03 g), m.p. 159-161° C. (dec.) (Found: C, 59.5; H, 7.3; N, 7.7%). ICP-AES Al, 5.0%. These values approximate to a composition of 58% (1:3, monomer) and 42% (2:5, dimer) of aluminium:ligand, which equates to: C, 60.2; H, 6.8; N, 7.9 and Al, 5.4%. I.r. νₘₐₓ (KBr) 3030w, 1577w, 1478s, 1256s and 743m cm⁻¹. ²⁷Al n.m.r. δ 34.2, br s. ¹H n.m.r. δ 3.13, s, NCH₃; 4.85, br s, CH₂NCH₃ and 6.51, m, ArH. ¹³C n.m.r. δ 44.2; 62.5; 118.3; 118.5; 121.1; 157.4 and 157.8. Mass spectrum 883 (13%), 776 (18), 717 (20), 525 (100), 480 (6), 358 (34) and 313 (11).

### EXAMPLE 35

Aluminium Complex with 3-(diethylaminomethylene)catechol

An off white powder (0.80 g), m.p. 129-132° C. (dec.) (Found: C, 66.5; H, 8.3; N, 6.7%). ICP-AES Al, 4.5%. These values approximate to a composition of 57% (1:3, monomer) and 43% (2:5, dimer) of aluminium:ligand, which equates to: C, 65.0; H, 7.8; N, 6.8 and Al, 4.7%. I.r. νₘₐₓ (KBr) 2974w, 1577w, 1477s, 1264s and 739m cm⁻¹. ²⁷Al n.m.r. δ 35.1, br s. ¹H n.m.r. δ 1.15, br s, NCH₂CH₃; 3.09, br s, NCH₂CH₃; 4.16, br s, CH₂NCH₂CH₃ and 6.50, m, ArH. ¹³C n.m.r. δ 10.5; 48.3; 57.1; 115.4; 115.6; 117.9; 120.2; 157.3 and 157.9. Mass spectrum 1023 (12%), 951 (5), 889 (14), 829 (6), 753 (7), 609 (100), 537 (3), 414 (25), 339 (8) and 195 (33).

### EXAMPLE 36

Aluminium Complex with 3-(dipropylaminomethylene)catechol

A very pale green powder (0.78 g), m.p. 150-156° C. (dec.) (Found: C, 69.6; H, 8.1; N, 5.6%). ICP-AES Al, 4.0%. These values approximate to a composition of 40% (1:3, monomer), 53% (2:5, dimer) and 7% (3:7, trimer) of aluminium:ligand, which equates to: C, 68.0; H, 8.6; N, 5.9 and Al, 4.3%. I.r. νₘₐₓ (KBr) 2964m, 2877s, 1574s, 1476s, 1260s and 738m cm⁻¹. ²⁷Al n.m.r. δ 34.8, br s. ¹H n.m.r. δ 0.83, br s, NCH₂CH₂CH₃; 1.62, m, NCH₂CH₂CH₃; 2.93, br. s, NCH₂CH₂CH₃; 4.15, br s, CH₂NCH₂CH₂CH₃; 6.43, appr. d, J 7.3 Hz ArH; 6.48, appr. t, J 7.5 Hz, ArH and 6.54, appr.d, J 7.3 Hz, ArH. ¹³C n.m.r. δ 13.1, 19.4, 52.1, 55.8, 115.2, 115.3, 117.7, 119.4, 157.5 and 157.8. Mass spectrum 1430 (6%), 1163 (44), 973 (84), 941 (64), 693 (98), 471 (100), 370 (22), 269 (22) and 224 (6).

### EXAMPLE 37

Aluminium Complex with 3-(dibutylaminomethylene)catechol

A pale green powder (0.71 g), m.p. 149-152° C. (dec.) (Found: C, 59.0; H, 7.4; N, 5.9%). Gravimetric Al, 4.5%. I.r. νₘₐₓ (KBr) 2960m, 2872w, 1578w, 1481s, 1259m and 738m cm^{-1 27}Al n.m.r. (CD₃OD) δ 34.9, br s. ¹H n.m.r. (CD₃OD) δ0.91, br t, J 6.7 Hz, N CH₂CH₂CH₂CH₃; 1.29, br m, NCH₂CH₂CH₂CH₃; 1.53, br m, NCH₂CH₂CH₂CH₃; 2.91, br m, NCH₂CH₂CH₂CH₃; 4.09, br s, CH₂NCH₂CH₂CH₂CH₃ and 6.34, br m, ArH. ¹³C n.m.r. (CD₃OD) δ 14.2; 21.2; 26.3; 52.0; 57.7; 112.5; 112.5; 113.9; 116.5; 119.9; 156.5 and 156.6. Mass spectrum 1735 (6%), 1597 98), 1304 (42), 1085 (100), 778 (56), 527 (34), 398 (8) and 252 (2).

### EXAMPLE 38

Solvent Partitioning

Silicon and aluminium complexes formed with Mannich base ligands show marked differences in their ability to partition between an aqueous and organic phase (examples of organic solvents are given below) depending on the length of the hydrocarbon chain. Below is a table illustrating the differences in partitioning ability between two solvent phases and is compared to the related catechol complexes.

General Synthetic Procedure for Solvent Partitioning Experiments

Each partitioning experiment is performed at 25° C. in a controlled temperature water bath. All solvents used are equilibrated at 25° C. for 1 hour prior to their use. Into a 5 ml quick fit test tube, the silicon(IV) complex (20.0 mg) is added and equilibrated at 25° C. for 20 minutes. To each test tube containing the complex, distilled water (1 ml) and an organic solvent (1 ml) is added, shaken and left to stand for 10 minutes. An aliquot (0.5 ml) of the organic layer is removed and evaporated from a pre weighed petri dish. The petri dish is reweighed and the amount of complex per ml and % recovery determined.

Solvent partitioning data for various Mannich base
silicon and aluminium complexes
% (w/w) recovery from the organic phase

| | | | Di-n-butyl | Ethyl | | n- |
|---|---|---|---|---|---|---|
| Complex | Toluene | n-Hexane | ether | acetate | MEK | Hexanol |
| Catechol-Si | 0 | 0 | 4 | 1 | 7 | 1 |
| Dimethyl | 0 | 0 | 1 | 0 | 6 | 2 |
| Mannich-Si | | | | | | |
| Diethyl | 0 | 0 | 2 | 6 | 12 | 16 |
| Mannich-Si | | | | | | |
| Dipropyl | 0 | 0 | 0 | 21 | 26 | 46 |
| Mannich-Si | | | | | | |
| Dibutyl | 0 | 0 | 0 | 55 | 64 | 59 |
| Mannich-Si | | | | | | |
| Catechol-Al | 0 | 1 | 5 | 3 | 11 | 8 |
| Dimethyl | 0 | 0 | 4 | 0 | 5 | 6 |
| Mannich-Al | | | | | | |
| Diethyl | 0 | 1 | 4 | 1 | 5 | 19 |
| Mannich-Al | | | | | | |
| Dipropyl | 0 | 0 | 5 | 27 | 48 | 63 |
| Mannich-Al | | | | | | |
| Dibutyl | 0 | 0 | 0 | 90 | 78 | 84 |
| Mannich-Al | | | | | | |

### EXAMPLE 39

Complex Formation in Aqueous Systems

The Mannich base ligands may be employed to form complexes with metal ions under aqueous conditions. To study the nature of the complexes of the metal ions with the Mannich base ligands in aqueous conditions, complexes were synthesised using the following general procedure. An aqueous solution of complexing ligand (0.1 M) is added to a round bottom containing an aqueous alkali solution of an appropriate metal salt. The metal solution is prepared with 10%(v/v) deuterium oxide (D₂O). The mixture is stirred for five minutes. After this time, an aliquot (2 mL) is taken and examined using nuclear magnetic resonance spectroscopy techniques. Both ¹³C and ²⁷Al NMR spectroscopy provided evidence of complex formation.

Using this technique, it was shown that complexes of Si⁴⁺, Al³⁺, Ti⁴⁺ and B³⁺ can all be formed under aqueous conditions.

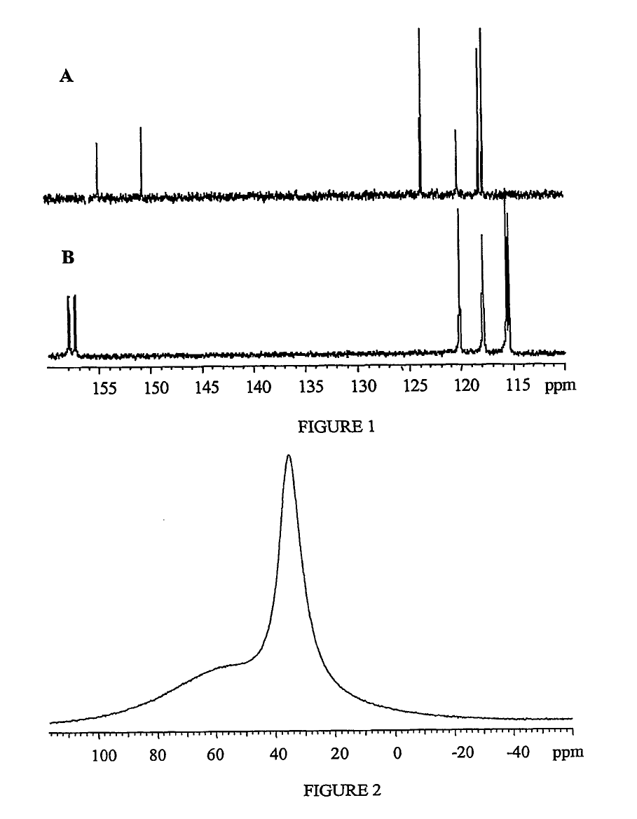

Comparison of 13C NMR spectral data obtained from uncoordinated Mannich base (spectrum A in FIG. 1) with the corresponding complex (spectrum B in FIG. 1) shows a significant difference. The two signals due to the phenolic carbons of the coordinated ligand are significantly broadened compared to the free ligand and resonate much closer together (separation of 60 Hz compared to >400 Hz in the uncoordinated ligand).

For complexes of the Mannich base ligand with aluminium, evidence of coordination can also be seen in the ²⁷Al NMR set out in FIG. 2. A single resonance centred around 35 ppm is observed due to coordinated aluminium.

### EXAMPLE 40

Regeneration of Mannich Base Ligands

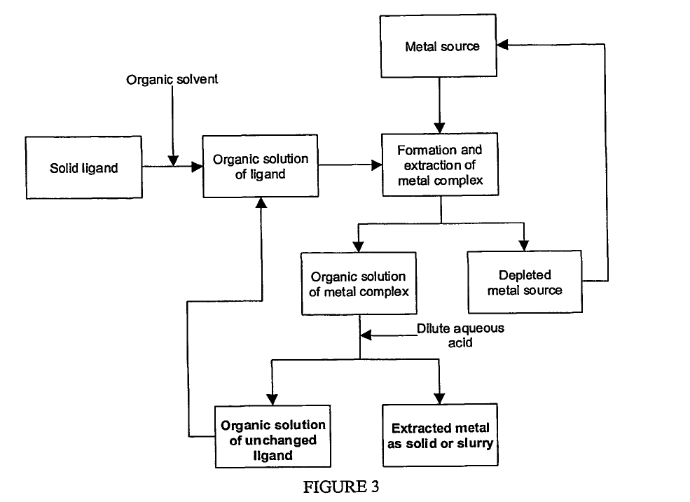

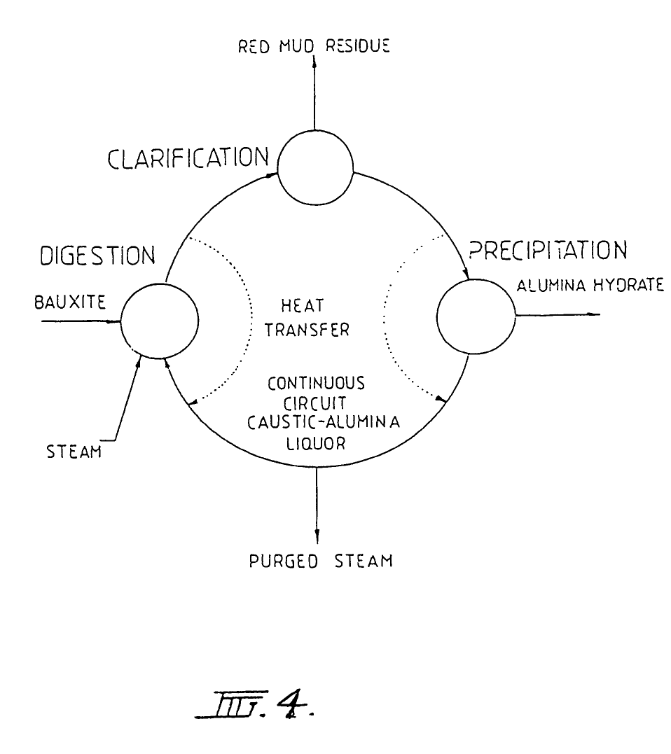

Whilst the metal complexes formed with these Mannich base ligands appear stable under aqueous and aqueous alkali conditions, they were found to decompose in slightly acidic aqueous solutions from which free, unchanged ligand and released metal can be recovered. More specifically the following procedure is an example of a suitable recovery scheme. The complex is hydrolysed in dilute hydrochloric acid solution (0.05 M)⁻ followed by neutralisation of the aqueous solution then extraction into an organic solvent. Suitable organic solvents include acetates (including ethyl acetate), ketones such as 2-butanone, chlorinated solvents, aliphatic and cyclic aliphatic solvents, aromatic solvents such as toluene, and commercial solvents such as kerosenes. This recovered ligand can be used again to form more complex. A flow chart for the process of extracting a target cation (for example a metal) from an aqueous solution containing the target cation and other cations, with the regeneration of the ligand is represented in FIG. 3.

### EXAMPLE 41

Additional Mannich Base Catechol Derivatives

Other Mannich base derivatives of catechol can be prepared via the application of the general synthetic method outlined in Example 1 above. Increasing the length of the alkyl tails on the ligand increases its organophilic character. However, ligands with longer alkyl tails have higher molecular weights and therefore a lower theoretical effectiveness (grams of metal complexed per gram of ligand). Accordingly, the preferred ligand will be one that has a maximum theoretical effectiveness.

The following table summarises starting amines, final ligand structures and their theoretical effectiveness. Theoretical effectiveness is calculated for the example of the tris complex with Si⁴⁺ metal ions.

Theoretical effectiveness data for various further Mannich base derivatives of catechol

| | | Theoretical |
|---|---|---|
| | | effectiveness for |
| Starting amine | Catechol derivative formed | silicon |
| 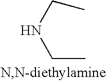 | 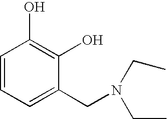 | 4.8 × 10⁻² |
| 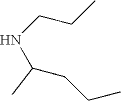 | 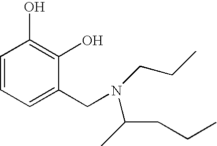 | 3.7 × 10⁻² |
| 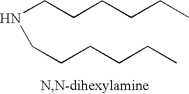 | 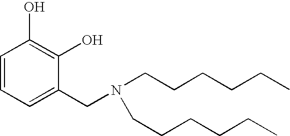 | 3.1 × 10⁻² |
| 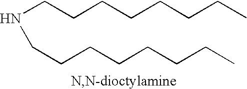 | 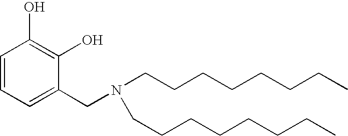 | 2.6 × 10⁻² |

### EXAMPLE 42

Application to Bayer Process

In current Bayer process methods, the pre-desilication step yields a high aluminium low silicon liquor and sodium aluminosilicate precipitate. The silicon level in the liquor can be maintained at much higher levels provided the liquor composition and reaction time and temperature are modified from those currently used which are designed to maxinise the desilication product precipitation. In that case the liquor contains both silicon and aluminium. After cooling of this liquor, the silicon and aluminium can be separated from one another in the liquor using the solvent extraction technique of the present invention. This involves selecting a organic solvent and ligand suitable for selectively extracting the aluminium ions (or the silicon ions) into the organic phase. By separating the aluminium ions from the silicon ions, the valuable aluminium can be recovered and the silicon removed in a more economical form.

### EXAMPLE 43

Alternative Method for Application to Bayer Process

In an alternative version of the Bayer process, a postdesilication step is conducted to form a separate desilication product (DSP). This post de-silication step is conducted after the digestion and red mud separation steps as illustrated in FIG. 4. The DSP is a mixed sodium aluminosilicate. The DSP is precipitated out of the Bayer liquor so as to reduce the level of silicon in the Bayer liquor, which leads to downstream processing difficulties and minimises alumina product contamination.

In this configuration the process of the present invention might be used either to remove the silicon directly from the digestion liquor prior to desilication occurring, analogous to treating the liquor from the desilication step as described above, or to remove any remaining aluminium from desilication product. The DSP contains significant quantities of valuable aluminium and sodium. The aluminium can be recovered from the DSP using the method of the present invention by:

i. Dissolving the DSP in a suitable liquor to solubilize the silicon, aluminium and sodium.

ii. complexing the aluminium ions (or, alternatively, the silicon ions) with a suitable ligand or ion exchange resin, and

iii. extracting the aluminium ion-ligand complex into an appropriate organic phase (in the case of the ligand), or conducting a solid—liquid separation to remove the solid resin (in the case of the resin).

Thereafter, by appropriate modification of the conditions, the aluminium ions can be released from the complex. One condition that may be modified to enable recovery of the target ion is pH.

It has been found from the experimental work conducted by the inventors that aluminium forms a complex with the ligands investigated in preference to silicon for values of pH greater than 14.

The remainder of the Bayer process is in accordance with the standard method which is well known in the art of the present invention, and need not be repeated here.

Since persons skilled in the art may readily effect modifications within the spirit and scope of the invention, it is to be understood that the invention is not limited to the particular embodiments described hereinabove or by way of the particular examples.

It is also to be understood that there will be many possible physical arrangements, equipment designs and equipment configurations that may be applied in the operation of the proposed process. Persons skilled in the art will readily effect the use of equipment technology combinations and flowsheet schemes commonly applied in the chemical engineering and metallurgical industries, and in the Bayer process, in the application of the process described herein, by merely following normal processes of testwork to define optimum parameters for the specific circumstances under consideration and engineering design.

The claims defining the invention are as follows:

1. Use of a compound comprising:
an aromatic component including two or more attachment sites for the cation;
an optionally substituted amine; and
a hydrocarbon chain of from 1 to 12 carbon atoms in length;
as a ligand in the formation of an internally neutralised complex with a cation, in which the amine nitrogen on at least one of the ligands is protonated so that the complex has an overall neutral charge without an external counterion.

2. Use as claimed in claim 1, wherein the cation is selected from the group consisting of metal cations and silicon, boron, germanium, arsenic and selenium.

3. Use as claimed in claim 1, wherein the compound is used to extract said cation from an aqueous solution.

4. Use as claimed in claim 3, wherein the compound is used to extract one or more cations selectively from other cations contained in the aqueous solution.

5. Use as claimed in claim 3, wherein the complex of the compound and cation is extracted into an organic solvent.

6. Use of a compound of formula I, a compound of formula II, a polymer of formula III or an ion-exchange resin of formula IV as a ligand in the formation of an internally neutralised complex with a cation, in which an amine nitrogen on at least one of the ligands is protonated so that the complex has an overall neutral charge; in which the formulae are as follows: 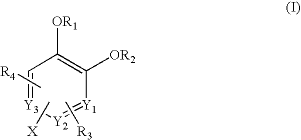
in which:
R₁ and R₂ are independently H, optionally substituted alkyl, alkenyl, alkynyl or aryl, or an oxygen protecting group;
R₁ and R₂ are independently H, optionally substituted alkyl alkenyl, alkynyl or aryl, or an oxygen protecting group;
R₃ is H, an optionally substituted alkyl, alkenyl, alkynyl or aryl, or an optionally substituted carbocyclic, heterocyclic, aromatic or heteroaromatic ring, or series of rings, fused to the ring of formula (1) represented above;
R₄ is H, —OR₅ or any other non-deleterious substituent;
R₅ is H or an optionally substituted alkyl, alkenyl, alkynyl or aryl;
Y₁, Y₂ and Y₃ are each independently CH or N; and
X is an amine; 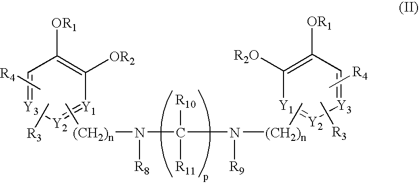
wherein:
R₁ and R₂ are independently H, optionally substituted alkyl, alkenyl alkynyl or aryl, or an oxygen protecting group;
R₃ is H, an optionally substituted alkyl, alkenyl, alkynyl or aryl, or an optionally substituted carbocyclic, heterocyclic, aromatic or heteroaromatic ring, or series of rings, fused to the respective ring or rings represented above;
R₄ is H, —OR₅ or any other non-deleterious substituent;
R₅ is H or an optionally substituted alkyl, alkenyl, alkynyl or aryl;
Y₁, Y₂ and Y₃ are each independently CH or N;
n is 0 or a positive integer;
p is a positive integer;
R₈ and R₉ are the same or different, and are each an optionally substituted straight chained, branched or cyclic alkyl group, or R₈ and R₉ may together form a substituted or unsubstituted, straight chained, branched or cyclic alkyl group linking the two nitrogen atoms; and
R₁₀ and R₁₁ are the same or different, and are each H or a substituted or unsubstituted branched or straight chained alkyl group;
R₃ is H, an optionally substituted alkyl, alkenyl, alkynyl or aryl, or an optionally substituted carbocyclic, heterocyclic, aromatic or heteroaromatic ring, or series of rings, fused to the ring of formula (O) represented above;
R₄ is H, —OR₅ or any other non-deleterious substituent;
R₅ is H or an optionally substituted alkyl, alkenyl, alkynyl or aryl;
Y₁, Y₂ and Y₃ are each independently CH or N; and
X is an amine; 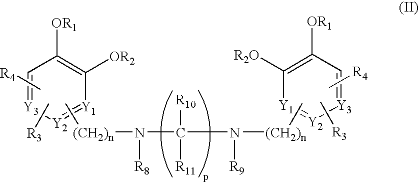
wherein:
R₁ and R₂ are independently H, optionally substituted alkyl, alkenyl alkynyl or aryl, or an oxygen protecting group;
R₃ is H, an optionally substituted alkyl, alkenyl, alkynyl or aryl, or an optionally substituted carbocyclic, heterocyclic, aromatic or heteroaromatic ring, or series of rings, fused to the respective ring or rings represented above;
R₄ is H, —OR₅ or any other non-deleterious substituent;
R₅ is H or an optionally substituted alkyl, alkenyl, alkynyl or aryl;
Y₁, Y₂ and Y₃ are each independently CH or N;
n is 0 or a positive integer;
p is a positive integer;
R₈ and R₉ are the same or different, and are each an optionally substituted straight chained, branched or cyclic alkyl group, or R₈ and R₉ may together form a substituted or unsubstituted, straight chained, branched or cyclic alkyl group linking the two nitrogen atoms; and
R₁₀ and R₁₁ are the same or different, and are each H or a substituted or unsubstituted branched or straight chained alkyl group; 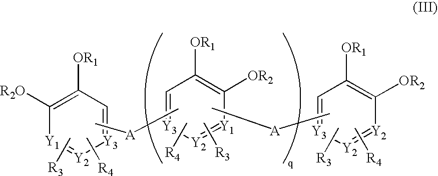
wherein:
q is a positive integer;
A is the following structure: 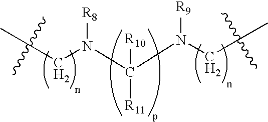
R₁ and R₂ are independently H, optionally substituted alkyl, alkenyl alkynyl or aryl, or an oxygen protecting group;
R₃ is H, an optionally substituted alkyl, alkenyl, alkynyl or aryl, or an optionally substituted carbocyclic, heterocyclic, aromatic or heteroaromatic ring, or series of rings, fused to the respective ring or rings represented above;
R₄ is H, —OR₅ or any other non-deleterious substituent;
R₅ is H or an optionally substituted alkyl, alkenyl, alkynyl or aryl;
Y₁, Y₂ and Y₃ are each independently CH or N;
n is 0 or a positive integer;
p is a positive integer;
R₈ and R₉ are the same or different, and are each an optionally substituted straight chained, branched or cyclic alkyl group, or R₈ and R₉ may together form a substituted or unsubstituted, straight chained, branched or cyclic alkyl group linking the two nitrogen atoms; and
R₁₀ and R₁₁ are the same or different, and are each H or a substituted or unsubstituted branched or straight chained alkyl group;
and wherein the polymer may contain cross-linking through R₈ and/or R₉; and 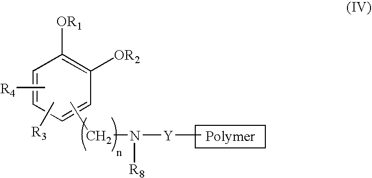
wherein:
R₁ and R₂ are independently H, optionally substituted alkyl, alkenyl alkynyl or aryl, or an oxygen protecting group;
R₃ is H, an optionally substituted alkyl, alkenyl, alkynyl or aryl, or an optionally substituted carbocyclic, heterocyclic, aromatic or heteroaromatic ring, or series of rings, fused to the respective ring or rings represented above;
R₄ is H, —OR₅ or any other non-deleterious substituent;
R₅ is H or an optionally substituted alkyl, alkenyl, alkynyl or aryl;
n is 0 or a positive integer;
R₈ is an optionally substituted straight chained, branched or cyclic alkyl group; and
Y is a direct bond or a divalent linking group.

7. Use as claimed in claim 6, wherein the cation is selected from the group consisting of metal cations and silicon, boron, germanium, arsenic and selenium.

8. Use as claimed in claim 6, wherein the compound, polymer or ion-exchange resin is used to extract said cation from an aqueous solution.

9. Use as claimed in claim 8, wherein the compound, polymer or ion-exchange resin is used to extract one or more cations selectively from other cations contained in the aqueous solution.

10. Use as claimed in any one of claims 6 to 9, wherein R₁ and R₂ in formulae I, II, III and IV are H.

11. Use as claimed in any one of claims 6 to 10, wherein R₃ in formulae I, II, III and IV is H.

12. Use as claimed in any one of claims 6 to 11, wherein R₄ in formulae I, II, III and IV is H.

13. Use as claimed in any one of claims 6 to 12, wherein Y₁, Y₂ and Y₃ in formulae I, II and III are each CH.

14. Use as claimed in any one of claims 6 to 13, wherein X in formula I is an optionally substituted saturated or unsaturated alkylamino, di(alkyl)amino, aminoalkyl, alkylaminoalkyl, or di(alkyl)aminoalkyl.

15. Use as claimed in any one of claims 6 to 13, wherein X in formula I is an aminoalkylene group of the structure: 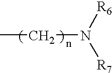
wherein
R₆ and R₇ are the same or different, and are each an optionally substituted straight chained, branched or cyclic alkyl group, which may be linked together to form a heterocyclic group containing the nitrogen atom illustrated, or one or both of R₆ and R₇ may be linked to another site on the compound to form a cyclic group containing the nitrogen atom illustrated, and
n is 0 or a positive integer.

16. Use as claimed in claim 15, wherein n is 1.

17. Use as claimed in claim 15, wherein R₆ and R₇ are independently a straight chained or branched C₁-C₁₀ alkyl group, a C₄-C₁₀ cyclic alkyl group or together form cyclic group containing from 4 to 10 carbon atoms, and one or more nitrogen atoms.

18. Use as claimed in any one of claims 6 to 17, wherein X in formula I is positioned ortho to the group OR₂.

19. Use as claimed in any one of claims 6 to 13, wherein in formula II, the nitrogen-containing chain linking the two aromatic rings together is attached at either end to each of the aromatic rings in a position ortho to the groups OR₂.

20. Use as claimed in any one of claims 6 to 13, wherein n in formulae II and III is a positive integer.

21. Use as claimed in claim 20, wherein n is 1.

22. Use as claimed in any one of claims 6 to 13, wherein R₈ and R₉ in formula II are independently selected from the group consisting of a straight chained or branched C₁-C₁₀ alkyl group, a C₄-C₁₀ cyclic alkyl group or together form a straight chained, branched or cyclic alkyl group linking the two nitrogen atoms together.

23. Use as claimed in any one of claims 6 to 13, wherein p in formula II or III is 2 or 3.

24. Use as claimed in any one of claims 6 to 13, wherein R₁₀ and R₁₁ are each H.

25. Use as claimed in any one of claims 6 to 13, wherein the polymer of formula m has an average molecular weight of between 330 and 15,000.

26. A method for extracting target cations from an aqueous solution comprising:
contacting the aqueous solution containing the target cations with a compound comprising an aromatic component including two or more attachment sites for the cation, an optionally substituted amine, and a hydrocarbon chain of from 1 to 12 carbon atoms in length;
forming a complex of the compound with the target cations, in which at least one amine nitrogen atom in the complex is protonated so that the complex has an overall neutral charge without an external counterion; and
separating the aqueous solution from the complex.

27. A method as claimed in claim 26, wherein the method includes the step of separating the target cations from the compound and reusing the compound for separating further target cations.

28. A method as claimed in claim 26 or claim 27, wherein the target cations are selectively separated from other ions in the aqueous solution.

29. A method as claimed in any one of claims 26 to 28, wherein target cations are one or more ions selected from the group consisting of metal cations and silicon, boron, germanium, arsenic and selenium.

30. A method as claimed in claim 29, wherein the target cations are selected from the group consisting of aluminium, silicon, titanium, boron, gallium, germanium, indium, tin, lead, uranium, gold, silver, arsenic, selenium, cadmium, mercury, chromium, copper and iron.

31. A method as claimed in any one of claims 26 to 30, wherein the method involves the selective separation of one species of target cation to the exclusion, or substantial exclusion, of other cations in the solution.

32. A method as claimed in any one of claims 26 to 31, wherein the aqueous solution contains dissolved silica and alumina, and the target cations are silicon ions.

33. A method as claimed in claim 32, wherein the aqueous solution is an aqueous liquor from the Bayer process.

34. A method for extracting target cations from an aqueous solution comprising:
contacting the aqueous solution containing the target cations with a compound of formula I, a compound of formula II, a polymer of formula III or an ion-exchange resin of formula IV, in which the formulae are as follows: 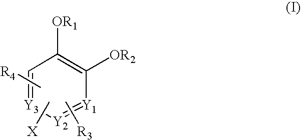
in which:
R₁ and R₂ are independently H, optionally substituted alkyl, alkenyl alkynyl or aryl, or an oxygen protecting group;
R₃ is H, an optionally substituted alkyl, alkenyl, alkynyl or aryl, or an optionally substituted carbocyclic, heterocyclic, aromatic or heteroaromatic ring, or series of rings, fused to the ring of formula (1) represented above;
R₄ is H, —OR₅ or any other non-deleterious substituent;
R₅ is H or an optionally substituted alkyl, alkenyl, alkynyl or aryl;
Y₁, Y₂ and Y₃ are each independently CH or N; and
X is an amine; 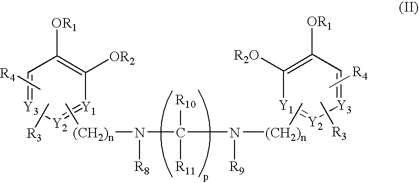
wherein:
R₁ and R₂ are independently H, optionally substituted alkyl, alkenyl alkynyl or aryl, or an oxygen protecting group;
R₃ is H, an optionally substituted alkyl, alkenyl, alkynyl or aryl, or an optionally substituted carbocyclic, heterocyclic, aromatic or heteroaromatic ring, or series of rings, fused to the respective ring or rings represented above;
R₄ is H, —OR₅ or any other non-deleterious substituent;
R₅ is H or an optionally substituted alkyl, alkenyl, alkynyl or aryl;
Y₁, Y₂ and Y₃ are each independently CH or N;
n is 0 or a positive integer;
p is a positive integer;
R₈ and R₉ are the same or different, and are each an optionally substituted straight chained, branched or cyclic alkyl group, or R₈ and R₉ may together form a substituted or unsubstituted, straight chained, branched or cyclic alkyl group linking the two nitrogen atoms; and
R₁₀ and R₁₁ are the same or different, and are each H or a substituted or unsubstituted branched or straight chained alkyl group; 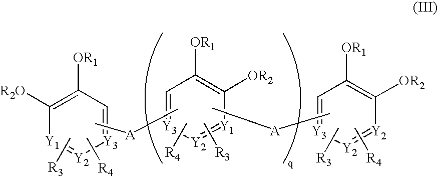
wherein:
q is a positive integer;
A is the following structure: 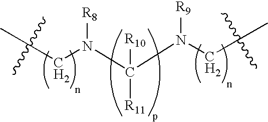
R₁ and R₂ are independently H, optionally substituted alkyl, alkenyl alkynyl or aryl, or an oxygen protecting group;
R₃ is H, an optionally substituted alkyl, alkenyl, alkynyl or aryl, or an optionally substituted carbocyclic, heterocyclic, aromatic or heteroaromatic ring, or series of rings, fused to the respective ring or rings represented above;
R₄ is H, —OR₅ or any other non-deleterious substituent;
R₅ is H or an optionally substituted alkyl, alkenyl, alkyl or aryl;
Y₁, Y₂ and Y₃ are each independently CH or N;
n is 0 or a positive integer;
p is a positive integer;
R₈ and R₉ are the same or different, and are each an optionally substituted straight chained, branched or cyclic alkyl group, or R₈ and R₉ may together form a substituted or unsubstituted, straight chained, branched or cyclic alkyl group linking the two nitrogen atoms; and
R₁₀ and R₁₁ are the same or different, and are each H or a substituted or unsubstituted branched or straight chained alkyl group;
and wherein the polymer may contain cross-linking through R₈ and/or R₉; and 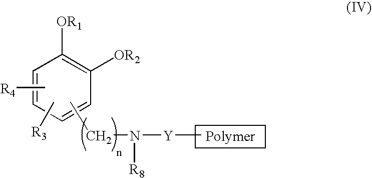
wherein:
R₁ and R₂ are independently H, optionally substituted alkyl, alkenyl alkynyl or aryl, or an oxygen protecting group;
R₃ is H, an optionally substituted alkyl, alkenyl, alkynyl or aryl, or an optionally substituted carbocyclic, heterocyclic, aromatic or heteroaromatic ring, or series of rings, fused to the respective ring or rings represented above;
R₄ is H, —OR₅ or any other non-deleterious substituent;
R₅ is H or an optionally substituted alkyl, alkenyl, alkynyl or aryl;
n is 0 or a positive integer;
R₈ is an optionally substituted straight chained, branched or cyclic alkyl group; and
Y is a direct bond or a divalent linking group;
forming a complex of the compound, polymer or ion exchange resin with the target cations, in which the amine nitrogen on at least one of the compounds, polymer or ion exchange resin in the complex is protonated so that the complex has an overall neutral charge without an external counterion; and
separating the aqueous solution from the complex.

35. A method as claimed in claim 34, wherein the method includes the step of separating the target cations from the compound, polymer or ion exchange resin, and reusing the compound polymer or ion exchange resin for separating further target cations.

36. A method as claimed in claim 34 or claim 35, wherein the target cations are selectively separated from other ions in the aqueous solution.

37. A method as claimed in any one of claims 34 to 36, wherein target cations are one or more ions selected from the group consisting of metal cations and silicon, boron, germanium, arsenic and selenium.

38. A method as claimed in claim 37, wherein the target cations are selected from the group consisting of aluminium, silicon, titanium, boron, gallium, germanium, indium, tin, lead, uranium, gold, silver, arsenic, selenium, cadmium, mercury, chromium, copper and iron.

39. A method as claimed in any one of claims 34 to 38, wherein the method involves the selective separation of one species of target cation to the exclusion, or substantial exclusion, of other cations in the solution.

40. A method as claimed in any one of claims 34 to 39, wherein the target cations are contacted with a compound of formulae I or II, or a polymer of formula III and the separation step comprises the step of extracting the complex into an organic phase, and separating the organic phase from the aqueous phase.

41. A method as claimed in any one of claims 34 to 39, wherein the target cations are contacted with an ion-exchange resin of formula IV and the separation step comprises the step of physically separating the exchange resin from the aqueous solution.

42. A method as claimed in any one of claims 34 to 41, wherein the aqueous solution contains dissolved silica and alumina, and the target cations are silicon ions.

43. A method as claimed in claim 42, wherein the aqueous solution is an aqueous liquor from the Bayer process.

44. A method as claimed in any one of claims 34 to 43, wherein R₁ and R₂ in formulae I, II, III and IV are H.

45. A method as claimed in any one of claims 34 to 44, wherein R₃ in formulae L II, III and IV is H.

46. A method as claimed in any one of claims 34 to 45, wherein R₄ in formulae I, II, III and IV is H.

47. A method as claimed in any one of claims 34 to 46, wherein Y₁, Y₂ and Y₃ in formulae I, II and III are each CH.

48. A method as claimed in any one of claims 34 to 47, wherein X in formula I is an optionally substituted saturated or unsaturated alkylamino, di(alkyl)amino, aminoalkyl, alkylaminoalkyl, or di(alkyl)aminoalkyl.

49. A method as claimed in any one of claims 34 to 47, wherein X in formula I is an aminoalkylene group of the structure: 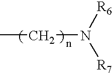
wherein
R₆ and R₇ are the same or different, and are each an optionally substituted straight chained, branched or cyclic alkyl group, which may be linked together to form a heterocyclic group containing the nitrogen atom illustrated, or one or both of R₆ and R₇ may be linked to another site on the compound to form a cyclic group containing the nitrogen atom illustrated, and
n is 0 or a positive integer.

50. A method as claimed in claim 49, wherein n is 1.

51. A method as claimed in claim 49, wherein R₆ and R₇ are independently a straight chained or branched C₁-C₁₀ alkyl group, a C₄-C₁₀ cyclic alkyl group or together form cyclic group containing from 4 to 10 carbon atoms, and one or more nitrogen atoms.

52. A method as claimed in any one of claims 34 to 51, wherein X in formula I is positioned ortho to the group OR₂.

53. A method as claimed in any one of claims 34 to 47, wherein in formula II, the nitrogen-containing chain linking the two aromatic rings together is attached at either end to each of the aromatic rings in a position ortho to the groups OR₂.

54. A method as claimed in any one of claims 34 to 47, wherein n in formulae II and m is a positive integer.

55. A method as claimed in claim 54, wherein n is 1.

56. A method as claimed in any one of claims 34 to 47, wherein R₈ and R₉ in formula II are independently selected from the group consisting of a straight chained or branched C₁-C₁₀ alkyl group, a C₄-C₁₀ cyclic alkyl group or together form a straight chained, branched or cyclic alkyl group linking the two nitrogen atoms together.

57. A method as claimed in any one of claims 34 to 47, wherein p in formulae II or M is 2 or 3.

58. A method as claimed in any one of claims 34 to 47, wherein R₁₀ and R₁₁ are each H.

59. A method as claimed in any one of claims 34 to 47, wherein the polymer of formula m has an average molecular weight of between 330 and 15,000.

60. A complex comprising:
a compound of formulae I or II, or a polymer of formula m or ion exchange resin of formula IV as defined in claim 6; and
a cation;
wherein the complex is self-neutralised by protonation of at least one nitrogen in the complex and the complex does not have an external counterion.
